(19) United States
(12) Patent Application Publication
(10) Pub. No.: US 2026/0192363 A1
(43) Pub. Date: Jul. 9, 2026

(54) PROCESS MAPPING FOR ADDITIVE MANUFACTURING USING MELT POOL TOPOLOGICAL FEATURES

(71) Applicant: Carnegie Mellon University, Pittsburgh, PA (US)

(72) Inventors: David Saad Guirguis Badrous, Pittsburgh, PA (US); Jack Beuth, Pittsburgh, PA (US); Conrad Tucker, Pittsburgh, PA (US)

(21) Appl. No.: 19/125,892

(22) PCT Filed: Nov. 3, 2023
(86) PCT No.: PCT/US2023/078686

§ 371 Date: Apr. 30, 2025

Related U.S. Application Data
(60) Provisional application No. 63/422,059, filed on Nov. 3, 2022.

(51) Int. Cl. B22F 10/85; B22F 10/22; B22F 10/36; B33Y 10/00; B33Y 50/02

(52) U.S. Cl. CPC B22F 10/85; B22F 10/22; B22F 10/36; B33Y 10/00; B33Y 50/02

(57) ABSTRACT

Methods and systems are for generating a process map for forming a structure, the process map usable for controlling additive manufacturing with the structure. The methods and systems are configured for obtaining a value of at least one process parameter for controlling thermo-fluid dynamics of the structure for melting material; heating, in accordance with the value of the at least one process parameter, the structure; obtaining a high-speed imaging of a melt pool; determining changes in a topological shape of the melt pool from the imaging; determining an absence or a presence of a defect in the structure representing whether the material is successful added to the structure; and generating a process map that correlates the value of the at least one process parameter to the absence or the presence of the defect in the structure.

### CLAIM OF PRIORITY

This application claims priority under 35 U.S.C. § 119 (e) to U.S. Patent Application Ser. No. 63/422,059, filed on Nov. 3, 2022, the entire contents of which are hereby incorporated by reference.

### GOVERNMENT SUPPORT CLAUSE

This invention was made with United States government support under W911NF-20-0175 awarded by the U.S. Army and SBIR (N162-083) awarded by the U.S. Navy. The U.S. government has certain rights in the invention.

### TECHNICAL FIELD

The present disclosure relates to an additive manufacturing process. Specially, this disclosure relates to controlling formation of parts from metals and metal alloys.

### BACKGROUND

Additive manufacturing (AM), also known as direct digital manufacturing, refers to a wide range of processes for the direct fabrication of final parts, functional prototypes, or both using rapid prototyping technology. In AM, parts are fabricated by deposition using a heat source to locally soften or melt material in order to fuse added material with existing material. In some AM processes (e.g., those based on friction stir welding), the material is heated enough to allow fusion of added and existing material without melting. In other AM processes, the material is melted, and as the heat source is translated across the part being fabricated, a bead is formed consisting of a moving melt pool with solidified material behind it. Material is fed into the heated region (either directly or by other techniques such as via a powder applied to the surface of the part), and the part is built up by multiple passes to form the part shape. AM is used for Free Form Fabrication (F³), which is the rapid manufacture of a complete part, and for additive manufacturing and repair (AMR), which adds one or more features to an existing component, either as a manufacturing step or for component repair. For instance, AM can be used to build parts from titanium alloys, which has applications in the aerospace and medical implant industries.

### SUMMARY

The present disclosure describes methods and systems relating to process mapping for manufacturing processes. The techniques described in this disclosure are applicable to a wide range of thermal processing methods. For illustration purposes, the techniques are described in the context of additive manufacturing involving a melt pool. In these additive manufacturing (AM) processes, a part is fabricated by deposition of successive beads of molten material. AM and other similar manufacturing processes are controlled by primary process variables, including, for instance, heat source power (P) and translation speed (V) of the heat source (e.g., a laser).

High-speed imaging is used to monitor the melt pool at a fine spatiotemporal scale. The high-speed imaging of the melt pool is optimized for in-situ process mapping by improving the ability of the data processing system to detect spatiotemporal features of the melt pool, as subsequently described. Extracted features are processed by a classifier that can include at least one machine learning model and classify the AM process as being stable (e.g., desired and without defects) or representative of a defect (such as keyhole, balling and/or lack-of-fusion defects). The feature extraction and classification are generalizable to many different kinds of alloys or metals for generation of process windows for those metals and alloys.

The methods and systems described herein are configured to control thermo-fluid dynamics of molten metal when the heat source is applied to the material and captured topological features of the melt pool on the material. The captured topological features are mapped to different potential outcomes of the additive manufacturing process. Specifically, the system captures a sequence of images (e.g., a video) of the melt pool as the melt pool changes over time. A data processing system is configured to extract topological features of the melt pool from the image data. The topological features can include a characteristic shape of the melt pool, including a combination of shape of the melt pool and the variability of the shape of the melt pool without requiring measured dimensional values such as width, depth, or area. Rather, a shape of the melt pool and how the shape changes for a set of frames (e.g., over time) are processed by the machine learning model to predict defects. Specific topological features (e.g., shape characteristics) are associated with same defects for a wide range of alloys. Rather, measured features, such width, area, or other size ratios are specific to a particular alloy.

The data processing system is configured to classify, based on the extracted features and using a trained machine learning model, an outcome for the additive manufacturing process. The outcome classification can include a determination of an absence of a defect in the material, or a stable (nominal, defect-free) output. The classification can specify that a defect is present in the material. Specifically, the data processing system can classify a type of the defect detected in the material, such as keyholing, balling, or lack of fusion detects, as subsequently described in further detail. In some implementations, the data processing system is configured to classify two or more defects as being present in the output material at the same time.

The data processing system can be configured to generate a process window that indicates a range for each of a set of process variables that, in combination, result in a desirable outcome for the additive manufacturing process. In general, the generation of process windows may enable the relationships between process variables and final part quality to be understood with minimal experimentation or simulation. The process window can be specific to a particular alloy or additive manufacturing system. The mapping is configured to map response behaviors (e.g., response times) of thermal process characteristics such as melt pool dimensions, solidification cooling rates, and average melt pool temperatures to value changes in identified process variables. The resulting process maps may be used to design process control systems that consider the mapped response times. In this system, powdered material rests on a metal surface, and is melted by the heat source.

The processes described herein may be implemented to realize one or more of the following advantages. The system includes a non-coaxial camera configuration. The non-coaxial camera configuration enables images to be captured of the melt pool that do not saturate the camera sensor. In typical systems, a coaxial camera configuration is used. The melt pool intensity is typically too high, and the sensor is saturated. In these systems, if the aperture size is reduced to reduce the intensity, detail of the melt pool topology is lost. In the present system, the non-coaxial camera configuration enables the data processing system to receive detailed images of the melt pool from which topological features of the melt pool can be extracted. The data processing system can track how the topological features change over time to classify the additive manufacturing as causing a desirable result or causing one or more defects in the material. Additionally, the data processing system includes a filter that is configured to remove artifacts of vapor emissions that can obscure the melt pool. An optical filter on the camera is configured to filter a set of wavelengths corresponding to peak wavelengths of vapor emissions from the material during bead disposition. The data processing system has a clear view of the topological features of the melt pool as a result of the filtering process.

The data processing system is configured to determine, based on images of the deposited bead after the molten metal cools, a correlation between the observed melt pool and the actual bead width of the deposited material. Specifically, the observed melt pool from the images does not necessary represent the true size of the bead being deposited. The data processing system is configured to generate a correction factor that determines a true size of the bead from the observed melt pool. In some implementations, the true bead size is used for developing a process window for a given alloy or for a given additive manufacturing process.

Variability analysis uses measured dimensions of the melt pool including area and width, as described herein. For example, determining, based on the sequence of images or video, changes in the topological shape of the melt pool during the period of time includes determining, for each image in the sequence of images, an area of the melt pool, a width of the melt pool, or each of the area and the width; and determining a value of a statistical variability of the area, the width, or both. In addition, the system determines the absence or the presence of the defect in the structure is based on the value of the statistical variability.

In some implementations, the variability analysis relies on the topological features of the melt pool instead of extracting the dimensions, temperature, and so forth. For example, the criteria of the ratio of dimensions of the melt pool are used to determine whether a defect is present can be different from one alloy to another, but the topology itself enables generalizability on different alloys without training the machine learning model on those particular alloys (e.g., without feeding the deep learning model with particular dimensions or ratios).

Implementations of the disclosure may include one or more of the following features.

In an aspect, a method is configured for generating a process map for forming a structure, the process map usable for controlling additive manufacturing with the structure. The method includes obtaining a value of at least one process parameter for controlling thermo-fluid dynamics of the structure for melting material to add the material to the structure. The method includes heating, in accordance with the value of the at least one process parameter, the structure, the heating forming a melt pool in the structure at which the material is added to the structure. The method includes obtaining a sequence of images representing the melt pool during a period of time. The method includes determining, based on the sequence of images, changes in a topological shape of the melt pool during the period of time. The method includes determining, based on the changes in the topological shape of the melt pool, an absence or a presence of a defect in the structure representing whether the material is successful added to the structure. The method includes generating, based on the changes in the topological shape of the melt pool, a process map that correlates the value of the at least one process parameter to the absence or the presence of the defect in the structure.

In some implementations, determining, based on the changes in the topological shape of the melt pool, the absence or the presence of the defect in the structure includes segmenting the sequence of images into non-overlapping three-dimensional (3D) patches in each of a spatial domain and a temporal domain. The determining can include accessing a video classification model comprising a multilayer perceptron (MLP) module. The determining can include generating a linear projection of each the 3D patches in each of the spatial domain and the temporal domain. The determining can include associating each linear projection with a positional embedding value. The determining can include generating, by feeding each linear projection and associated positional embedding value into the MLP module, a classification of the sequence of images as representing the absence or the presence of the defect in the structure.

In some implementations, the absence of the defect is indicative that the value of the at least one process parameter is within a process window for adding the material to the structure to cause a depth to width melt pool ratio of between 5:6 to 1:2.

In some implementations, the presence of the defect is indicative of at least one of a keyhole formation at the melt pool, a balling formation at the melt pool, or a lack of fusion of the material to the structure.

In some implementations, determining, based on the sequence of images, changes in the topological shape of the melt pool during the period of time comprises determining, for each image in the sequence of images, an area of the melt pool, a width of the melt pool, or each of the area and the width and determining a value of a statistical variability of the area, the width, or both, wherein determining the absence or the presence of the defect in the structure is based on the value of the statistical variability. In some implementations, the value of statistical variability comprises a standard deviation value.

In some implementations, the method includes normalizing an image intensity across the sequence of images by linearly scaling pixel intensities in each image.

In some implementations, the method includes filtering, from the each of the images of the sequence, distortions caused by vapor plasma in one or more of the images in the sequence of images based on application of an optical filter that blocks a set of wavelengths associated with peak or near-peak emissions of the vapor plasma.

In some implementations, the method includes, based on application of a pixel intensity threshold, determining, from the sequence of images representing the melt pool, an estimated melt pool boundary; measuring a width of the material that is deposited on the structure corresponding to the period of time; generating a correction factor based on a correlation between the width of the material and the estimated melt pool boundary; and generating, based on the correction factor and the estimated melt pool boundary, data representing a corrected melt pool boundary.

In some implementations, determining the changes in the topological shape of the melt pool during the period of time is based on the corrected melt pool boundary.

In some implementations, the method includes correlating the correction factor to at least one setting for a sensor for capturing the sequence of images.

In some implementations, the at least one process parameter is selected from a group comprising a laser power (P) for a laser configured to heat the structure or a translation speed (V) for moving the laser over the structure.

In some implementations, the method includes generating a process window based on the process map, the process window specifying one or more values for process parameters including the value of the at least one process parameter for controlling a microstructure of a particular alloy or metal forming the structure and avoiding defects in the structure.

In some implementations, the method includes generating a process window based on the process map, the process window specifying one or more values for process parameters including the value of the at least one process parameter for maximizing a build rate of a part including a particular alloy or metal forming the structure and avoiding defects in the structure.

In some implementations, the method includes generating a process window based on the process map, the process window specifying one or more values for process parameters including the value of the at least one process parameter for minimizing melt pool variability.

In some implementations, the method includes generating a process window based on the process map, the process window specifying one or more values for process parameters including the value of the at least one process parameter for minimizing a heat buildup in a part including a particular alloy or metal while forming the structure and avoiding defects in the structure.

In some implementations, the period of time is less than one millisecond.

In some implementations, the sequence of images is captured at a frame rate of at least 5,000 frames per second and up to 60,000 frames per second.

In some implementations, the sequence of images captured includes visible light, near-infrared radiation, or both.

In some implementations, the structure comprises one of a Ti-6A1-4V alloy, a SS316L allow, or a IN718 alloy.

In some implementations, the structure comprises one of a titanium alloy, an aluminum alloy, a chromium alloy, a nickel alloy, a copper alloy, a tungsten alloy, a tantalum alloy, or an iron alloy.

In an aspect, a method is configured for generating a process map for forming a structure, the process map being usable for controlling additive manufacturing with the structure. The method includes obtaining a value of at least one process parameter for controlling heating of the structure for adding material to the structure. The method includes heating, in accordance with the value of the at least one process parameter, the structure, the heating forming a melt pool in the structure at which the material is added to the structure. The method includes obtaining a sequence of images representing the melt pool during a period of time. The method includes filtering, from the each of the images of the sequence, distortions caused by vapor plasma in the image. The method includes determining, based on the sequence of images, an absence or a presence of a defect in the structure representing whether the material is successful added to the structure. The method includes generating a process map that correlates the value of the at least one process parameter to the absence or the presence of the defect in the structure.

In an aspect, a method is configured for generating a process map for forming a structure, the process map being usable for controlling additive manufacturing with the structure. The method includes obtaining a value of at least one process parameter for controlling heating of the structure for adding material to the structure. The method includes heating, in accordance with the value of the at least one process parameter, the structure, the heating forming a melt pool in the structure at which the material is added to the structure. The method includes obtaining a sequence of images representing the melt pool during a period of time. The method includes classifying, based on the sequence of images, the structure having a defect of a specific type or not having a defect. The method includes generating a process map that correlates the value of the at least one process parameter to the classification of the structure.

In an aspect, a system is configured for generating a process map for forming a structure, the process map being usable for controlling additive manufacturing with the structure. The system includes one or more sensors and processors for performing operations for any of the methods described herein.

In an aspect, one or more non-transitory computer readable media store instructions that, when executed by one or more processors, are configured for generating a process map for forming a structure, the process map being usable for controlling additive manufacturing with the structure. The one or more non-transitory computer readable media include one or more processors configured for performing operations for any of the methods described herein.

Details of one or more implementations are set forth in the accompanying drawings and the description below. Other features, objects, and advantages will be apparent from the description, the drawings, and the claims.

### BRIEF DESCRIPTION OF FIGURES

FIGS. 1A-1B show a block diagram of an example system for measuring melt pool topological features during a beam-based additive manufacturing (AM) process.

FIG. 1C shows an example machine learning model.

FIG. 1D shows an example of filtering.

FIGS. 2A-2G show diagrams of example melt pool topologies.

FIGS. 3A-3C include graphs showing maximum intensity values corresponding to classified output states of the AM process.

FIGS. 4A-4D show images of example melt pools and deposited beads for the AM process.

FIGS. 5A-5C show graphs of process windows representing classified outputs for the AM process.

FIGS. 6A-6C show examples of classification output accuracies.

FIG. 7 shows examples of classification output accuracies.

FIG. 8 shows examples of classification output accuracies.

FIG. 9 shows examples of process maps.

FIG. 10 shows process parameter clusters and an attention map.

FIG. 11 shows an example process.

FIG. 12 is a block diagram of an example of a processing system environment for generating a process map.

### DETAILED DESCRIPTION

Addressing uncertainty and variability in the quality of 3D printing of metals can lead to a wider spread of the technology. Process mapping for new alloys is crucial to determine optimal process parameters that produce acceptable printing quality consistently. Process mapping is typically performed by conventional methods of the design of experiments and ex-situ characterization of printed parts. On the other hand, in-situ approaches are limited due to poor observable features and the need to use complex high-cost setups for temperature measurement to boost accuracy. Our method relaxes these limitations by incorporating the temporal features of molten metal dynamics during laser-metal interaction using video classification models and high-speed imaging. Our approach can be used in existing commercial machines and provide in-situ process maps for defects and variability quantification efficiently. The generalizability of the approach is demonstrated by performing cross-dataset evaluation on alloys with different compositions and intrinsic thermo-fluid properties.

The techniques described herein provide a method for mapping the response behaviors (e.g., response times) of thermal process characteristics such as melt pool dimensions, solidification cooling rates, and average melt pool temperatures to value changes in identified process variables. The resulting process maps may be used to design process control systems that take into account the mapped response times. The techniques described herein are applicable to the deposition of beads of material used to build up complex three-dimensional shapes. The techniques can be applied to processes where no material is added. The techniques can be applied to map the response behavior of any thermal process characteristic in processes that do not include a melt pool. Although AM processes typically use a laser or electron beam as a heat source, the techniques can be applied to processes using any type of heat source. Process mapping is described in detail in U.S. Pat. No. 10,328,532, filed on Sep. 14, 2015 and issued on Jun. 25, 2019 and titled “Process Mapping of Average Temperatures and Process Sensitivity”, and in U.S. Pat. No. 10,035,220, filed on Sep. 14, 2014 and issued on Jul. 31, 2018, titled “Process Mapping of Transient Thermal Response Due to Value Changes in a Process Variable,” the contents of each of which are hereby incorporated by reference in entirety.

Specifically, processing mapping includes mapping the role of primary process variables (in particular, an initial set of values and a final set of values) in determining the response behavior of a thermal process characteristic resulting from a change in values of primary process variables, as secondary process variables are held constant. The techniques can also be used in cases where secondary processes vary, but they are determined by the primary process variables. In cases where secondary process variables change independently or randomly, the techniques can help identify when they affect response behavior by first separating out the role of the primary process variables. Once this is done, studies of secondary process variables can be performed by adding them to the process variable list and mapping their influence on process characteristics under steady-state and transient conditions.

The thermal characteristics that are mapped for their transient behavior can be any quantity related to the thermal field, including thermal field dimensions, temperature derivatives (in time or space), temperature integrals (in time or space), or combinations of these. The thermal characteristic is determined for the first set of values of the process variables, for the transition between the first set and second set of values of the process variables, and for the second set of values of the process variables. A process map of the thermal characteristic may be generated as a function of the first set of values and the second set of values of the process variables.

The resulting transient process maps may be used to determine when and how to change process variables to achieve a desired process characteristic transient behavior. For instance, the process maps may be used as a guide to determine at what time in advance of encountering a change in deposition geometry a process variable change is needed to maintain the process characteristic of melt pool size. The process maps may also be used as a guide to how to change primary process variables in order to achieve a desired response behavior, such as temporarily increasing the magnitude of a power change to decrease the time needed to change melt pool size. The process maps may be used to identify pairs of initial and final values of process variables that yield a similar transitional behavior.

The techniques described herein are applicable to the deposition of beads of material onto an existing large plate. These techniques can also be applied to the fabrication of more complex three-dimensional shapes. Although AM processes are typically used to fabricate metal parts, the techniques described herein can be used to support the fabrication of parts of any material compatible with thermal AM processing, welding, beam-based surface heat treating, or other similar manufacturing processes. As described in this disclosure, process maps are developed for a single material or a specified combination of materials. If the material or material combination is changed, new process maps should be developed.

The method may include generating a plurality of process maps characterizing the thermal process for forming the structure, each process map corresponding to at least one of a topology of the structure and a temperature of the structure. The method may include decomposing a fabrication of a complex structure into a combination of one or more geometries; and controlling the fabrication of the complex structure based on the process maps for forming each of the one or more geometries. A topology of the complex structure may include at least one of a height of the topology and a width of the topology. The structure may include a part that is fabricated in the thermal process. The actions of conducting and generating are implemented by one or more processing devices.

The process variables of each of the first and second combinations may be selected from a group comprising a power (P) variable associated with the thermal process, a translation speed (V) variable associated with the thermal process, a material feed rate (MFR) variable (or variable related to MFR), used in the thermal process, one or more structure geometry variables, and a structure temperature (TO) variable.

Laser powder bed fusion (L-PBF) is the most widely used technology for printing metal alloys. The system uses a high-power laser as an energy source to melt and fuse powders in specific locations to form certain shapes, a recoater then spreads a new layer of powder, and the process repeats until 3D objects are formed.

The systems described herein are configured to track variability in the melt pool topology over time using high-speed imaging. The variability is measured and used to train machine learning models that classify the variability as representing defects in the AM process or not. By tracking and mapping variability, the systems described herein can overcome it as an obstacle that hinders the reliability of the quality of printed parts and thus the potential for full production. Specifically, mechanical properties and dimensional accuracy of printed parts vary depending on the powder and machine used, scanning strategy, and printing conditions. This can cause a lack of repeatability and uncertainty in quality. The systems described herein mare configured to determine an influence of decisive parameters determine process-properties relationships to find ways to control the quality and microstructure properties of printed objects.

Moreover, mapping the process parameters into the printing defects is essential to determine the optimum process parameters for each type of metal alloy and printing facility. Process development is typically performed by laboratory technicians using ex-situ facilities where printed tracks are characterized. Laser beam power and velocity are two major machine parameters that directly control the laser energy density and, therefore the stability of the molten pool of metal. Additionally, adequate spacing between laser scan tracks is determined by considering the variability and uncertainty in the width of the printed tracks for sufficient overlapping between each pair of melted and fused tracks to avoid leaving un-melted powder behind. This type of defect can deteriorate the mechanical properties and reduce fatigue life.

High-speed imaging is used to monitor the molten pool by the laser at a fine spatiotemporal scale. The camera placement, filtering, intensity normalization, and other image processing techniques described herein enable adoption of high-speed imaging for in-situ process mapping by enabling extraction of features of the melt pool (such as topology variability). In addition, machine learning models are configured to classify these topological features (and the variability of these features) as representative of descried output or one or more of the defects including keyholding, balling, and lack of fusion of the powder. These aspects of the system can reduce or eliminate requirements for imaging alignment, calibration, and a special setups to be integrated with the scanning head of a 3D printing machine.

The in-situ approach for an accelerated and efficient process design for 3D printing of new metal alloys achieves melt-pool stability and addresses melt pool variability. The system described herein can avoid pixel intensity saturation in captured frames by the high-speed camera and enable feature extraction of the melt pool to monitor the dynamic changes of the molten pool and use the temporal data to classify the process into different types of defects.

The machine learning models can include video vision transformers. In some implementations, video vision transformers are used instead of convolutional neural network (CNN) and traditional computer vision approaches of static images. However, other such machine learning models can be integrated into the system and methods described herein. The particular video vision transformer used in an example has had very high accuracy. For example, algorithmic accuracy can exceed 98% (depending on the selected alloy) without a need to use an advanced setup of high-cost pyrometers to extract the temperature field. In some implementations, the accuracy can be around 90%. In some implementations, the accuracy exceeds 90%.

This system and process is generalizable to most any metal or alloy system. While several alloys are shown herein as representative, most any alloy can be substituted for mapping topological variability with the trained machine learning models without requiring retraining of the models. For example, the system is shown with a set of selected metal alloys that are not used to train the vision transformer model and achieved top-1 accuracy up to 98%. In addition, to address the variability problem, variability process maps are generated for molten pool attributes to guide for determination of optimal hatch spacing.

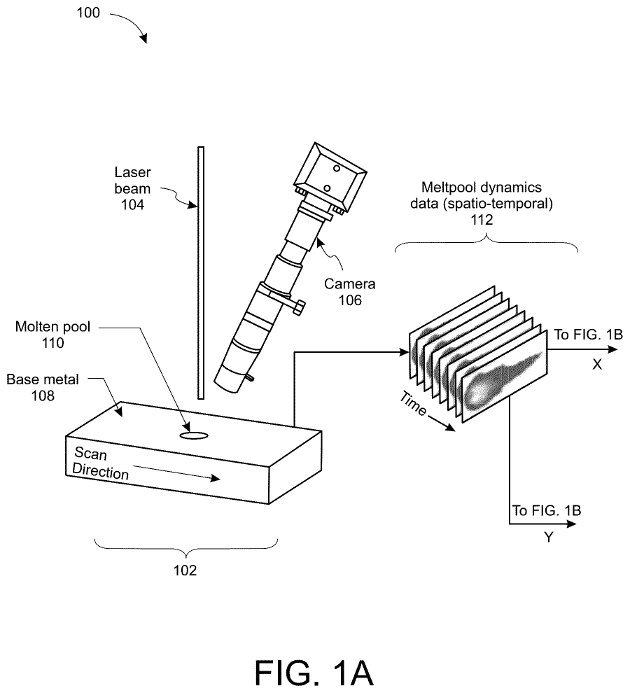

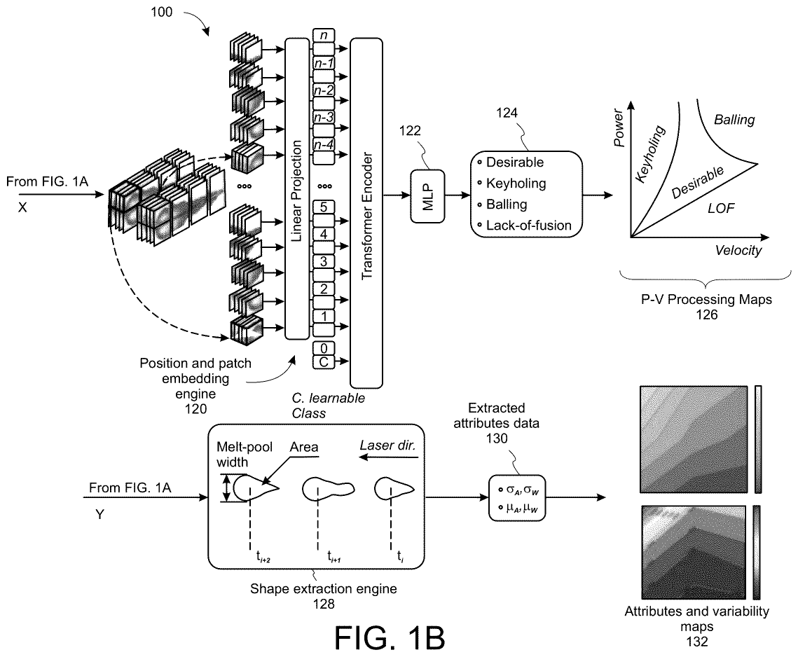

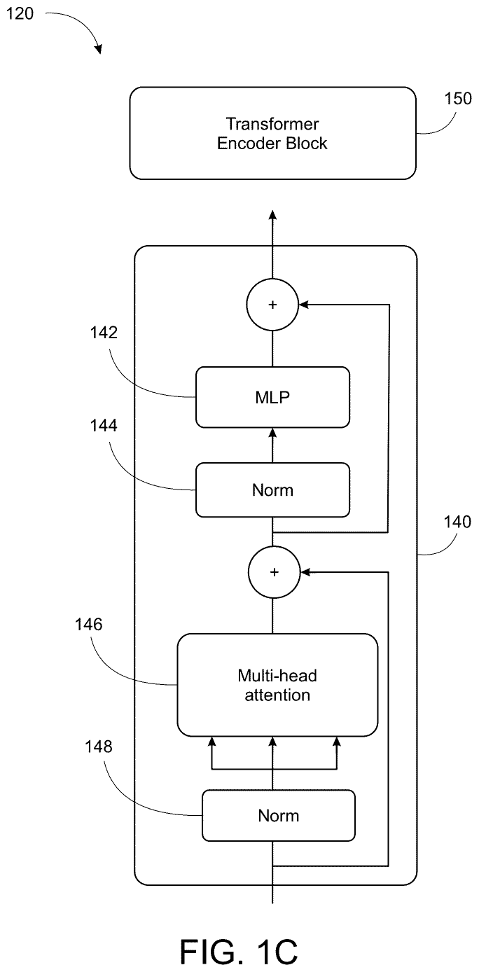

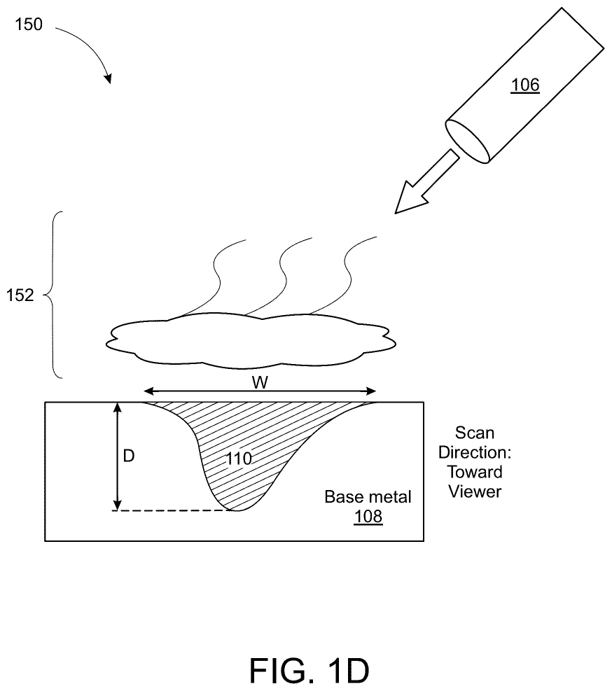

FIGS. 1A-1B show a block diagram of an example system 100 for measuring melt pool topological features during a beam-based additive manufacturing (AM) process. The system 100 includes a structure includes a base metal 102 and a powder 108 over which a heat source 104 (e.g., a laser beam) is scanned, and a high-speed camera 106. The laser 104 causes a melt pool 110 (also called a molten pool) in the base metal 102 and powder 108. Generally, metal powder is deposited on the metal 102 for forming the structures for the AM process.

A set of data 112 including the melt pool dynamics are captured by the camera. As further described herein, the camera 106 is located non-coaxially with the laser 104. This reduces intensity of light emitted from the melt pool and enables extraction of the spatiotemporal topological features from the melt pool. Additionally, a filter (such as an optical filter) is applied that removes peak emission wavelengths from the vapor generated by the melt pool. Example wavelengths are between about 640-700 nanometers. In some implementations, other optical filters can be used with other optical ranges. This filtering further enables extraction of topological features from the melt pool because it enables a clearer image of the melt pool. The optical train is devised to block the wavelength that is associated with most of the emissions of the plasma plume, such as ionized vapor, condensed particles, and plume formed during printing. The plume temperature alone can be higher than 3500 Kelvin (K).

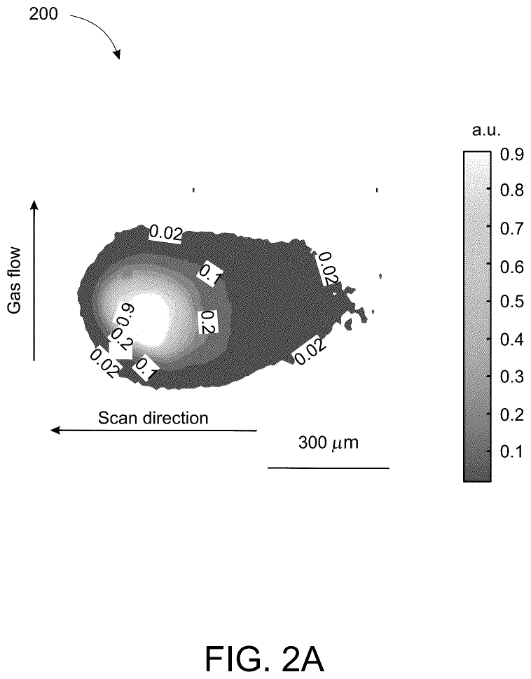

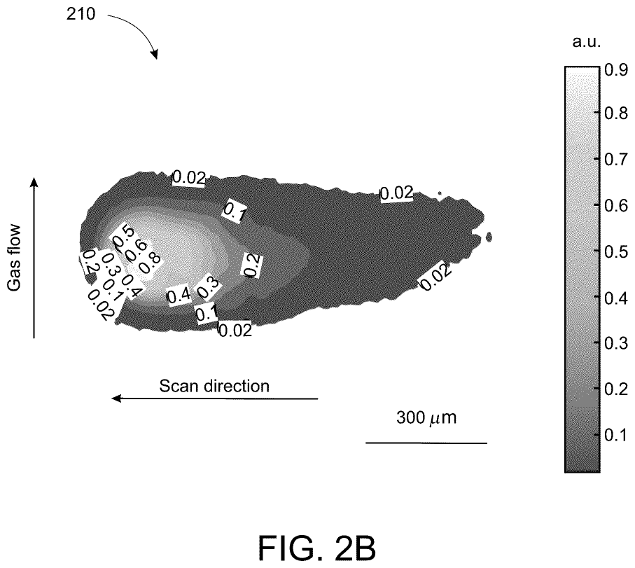

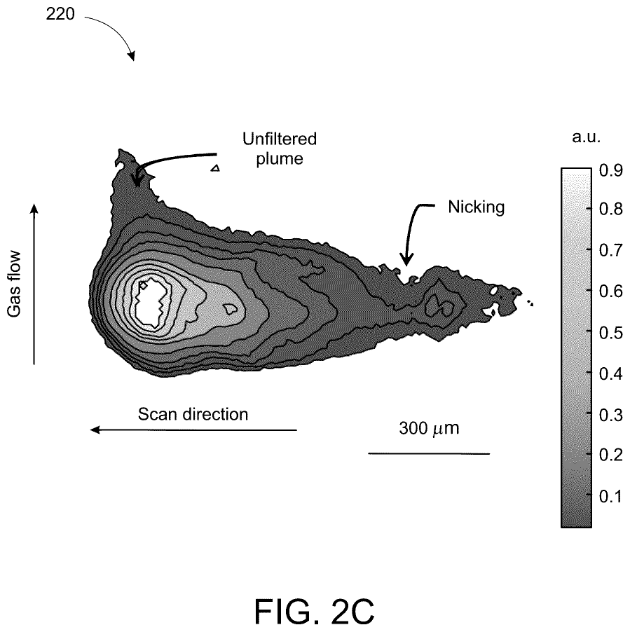

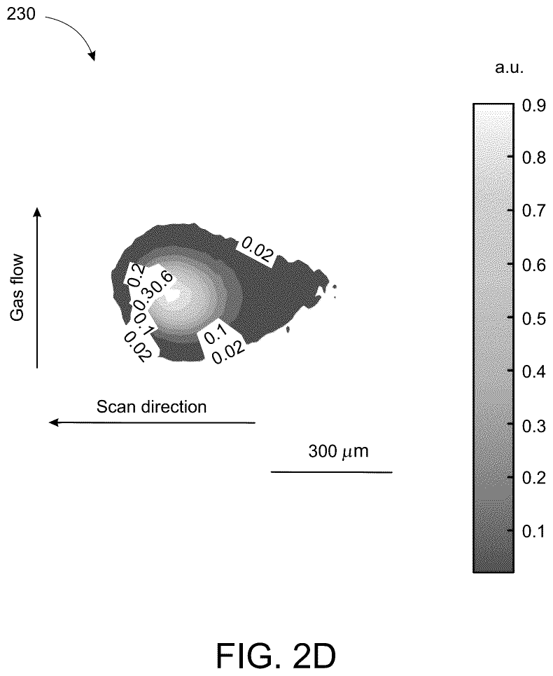

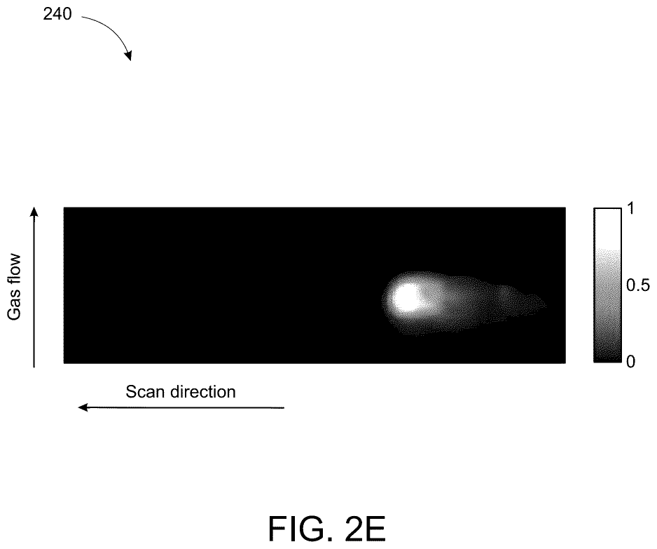

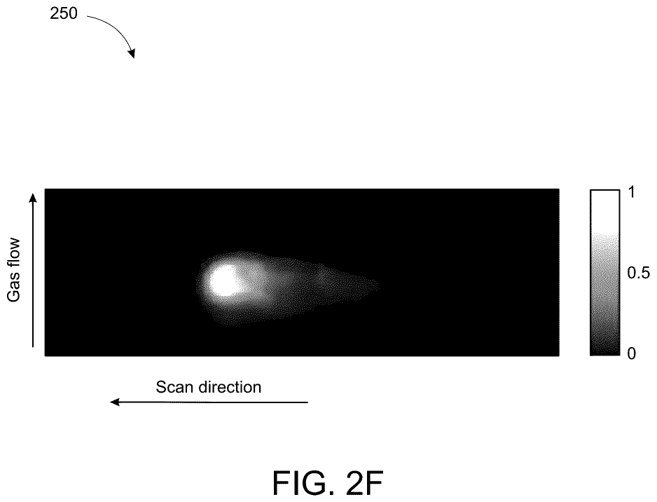

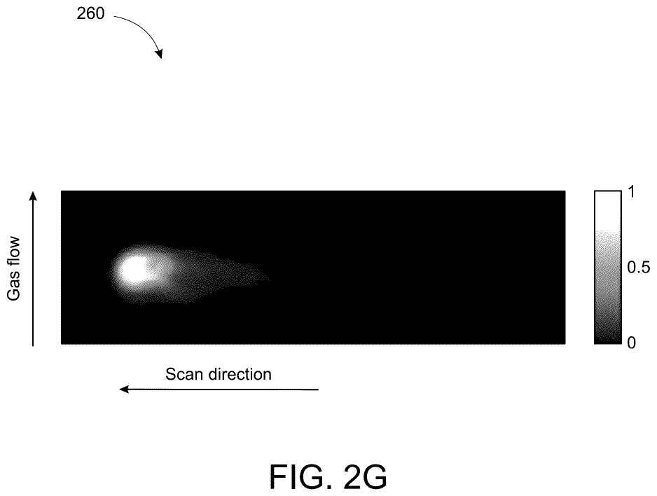

The intensity values of the pixels can be normalized, and from these normalized pixel intensity values, melt pool topology and its variation over time are obtained. Examples of melt pool data are shown in FIGS. 2A-2G.

The spatiotemporal melt pool data 112 are input into a machine learning model including a position and patch embedding engine 120 and a shape extraction engine 128. The position and patch embedding engine includes segmenting the melt pool images into patches, generating linear projections of the patches, and inputting these linear projections into a transformer encoder.

A data processing system executing the logic of engine 120 is configured to segment the sequence of images 112 into non-overlapping three-dimensional (3D) patches in each of a spatial domain and a temporal domain. The data processing system accesses the video vision transformer model comprising a multilayer perceptron (MLP) module 124. The data processing system generates a linear projection of each the 3D patches in each of the spatial domain and the temporal domain and associates each linear projection with a positional embedding value. The data processing system generates, by feeding each linear projection and associated positional embedding value into the MLP module 122, a classification 124 of the sequence of images as representing the absence or the presence of the defect in the structure. Details of the model are shown in Arnab et. al, ViViT: A Video Vision Transformer, arxiv, published 2021 (https://arxiv.org/abs/2103.15691), the contents of which are incorporated by reference herein in entirety.

The classification outputs 124 represent either a desirable state or a presence of one or more specific defects in the AM structure, including keyholing, balling, and lack-of-fusion defects. P-V process maps 126 are generated by a data processing system from the classification outputs 124 by comparing to the processing parameters that generated those classified outputs, as described further below. The data processing system also extracts shape attributes 130 from the measured topology of the melt pool to generate attributes and variability maps 132, as subsequently described in further detail. The system is configured to determine, based on the changes in the topological shape of the melt pool, an absence or a presence of the defect in the metal 108. The specifics of these models 120, 128, and 122 are now described.

FIG. 1D shows an example system 150 in which filtering of vapor emissions 152 can be performed. A melt pool 110 is shown with a width W and depth D. The scan direction is towards the viewer. The camera 106 is non-coaxial. As previously discussed, the filtering removes the peak wavelength emissions of the vapors 152, enabling improved melt pool topology feature extraction.

### Capturing Melt Pool Dynamics

Representative results of melt pool frames captured at different printing regimes are shown in FIGS. 2A-2G, subsequently described in greater detail. In an example, the data 112 including high-speed imaging videos are recorded at a high rate of 54,000 frames per second in order to capture the high-frequent oscillation in the melt pool shape. The gradients of the melt pool light emission are clearer than frames captured by other direct imaging setups. In addition, the melt pool geometric attributes are intuitively reasonable and are matched with frames captured with calibrated setups for temperature measurements and imaging setups with illuminated scenes.

FIGS. 2A-2D show example features for melt pools associated with process parameters for beam power and velocity. FIG. 2A shows an example 200 of melt pool features in which keyholing occurs (350W, and 600 mm/s). FIG. 2B shows example melt pool features 210 in which the melt pool is stable (320W, and 1200 mm/s). FIG. 2C shows an example of melt pool features 220 in which balling occurs (400W, and 1800 mm/s). FIG. 2D shows an example of melt pool features 230 in which lack-of-fusion occurs (150W, and 1500 mm/s).

FIGS. 2E-2G show select images from a high-speed video capture in which features for melt pools associated with process parameters for beam power and velocity are extracted. FIG. 2E shows an image 240 at a first time. FIG. 2F shows an image 250 at a second time later than the first time. FIG. 2G shows an image 260 at a third time later than the second time. In each image 240, 250, and 260, the melt pool topology is clearly visible. The vapor artefacts are filtered away and the pixel intensities are normalized.

The melt pool becomes smaller but elongates as the scan speed increases. However, melt pools captured in the lack-of-fusion regime are very small with a low length-to-width ratio as the energy density is very low and the laser beam does not penetrate deeply into the material. Although the captured melt pools are clear from significant signs of plasma and plume, they are observable with high oscillations in the keyholing regime. In the keyholing regime, owing to the high energy density the vapor plasma is significantly higher and cannot be easily filtered out. In balling regime, in agreement with the modeling study, the molten pool elongates and disconnects leaving behind peaks in the track. A post-processed frame extracted from a video captured at a P-V combination that is known to be associated with the balling regime is shown in FIG. 2C.

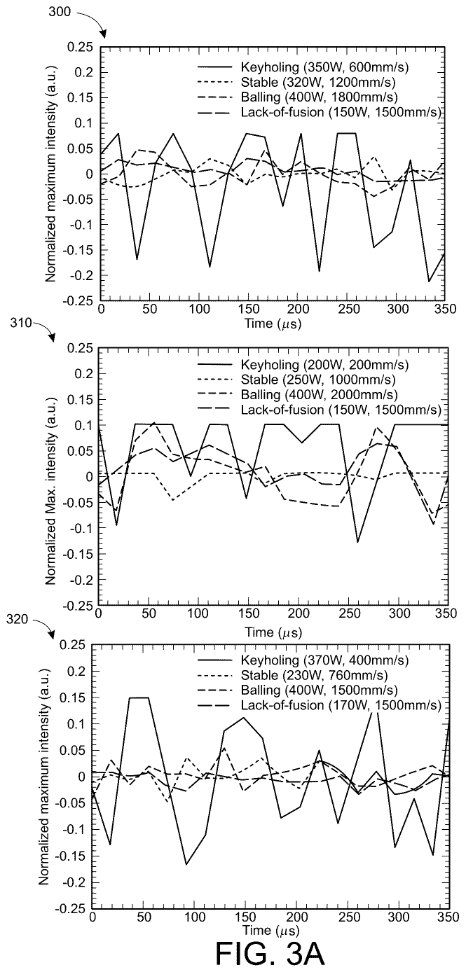

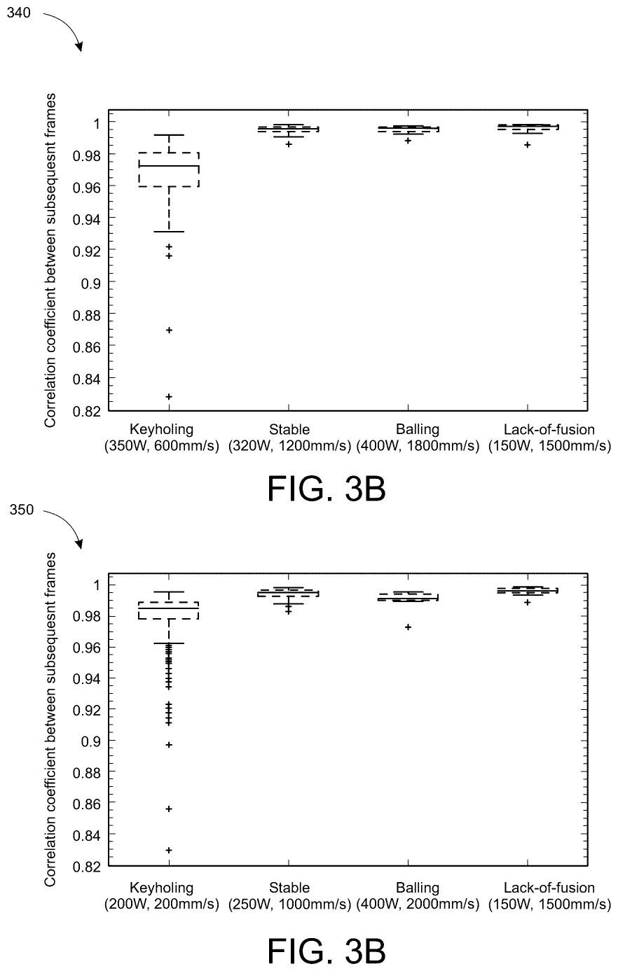

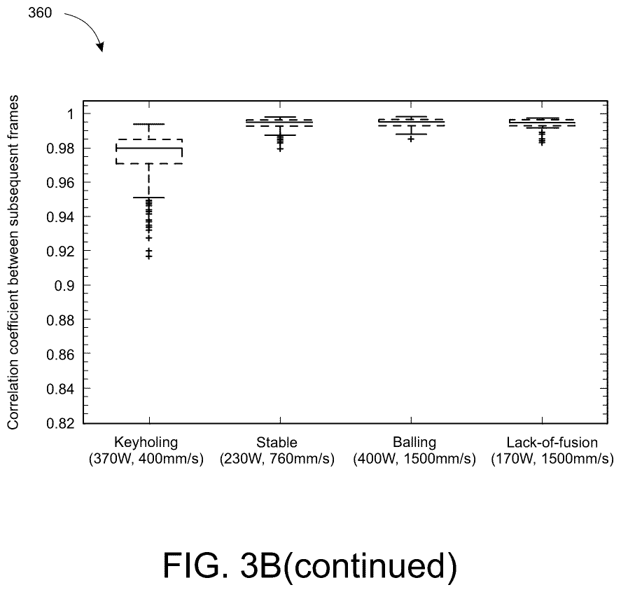

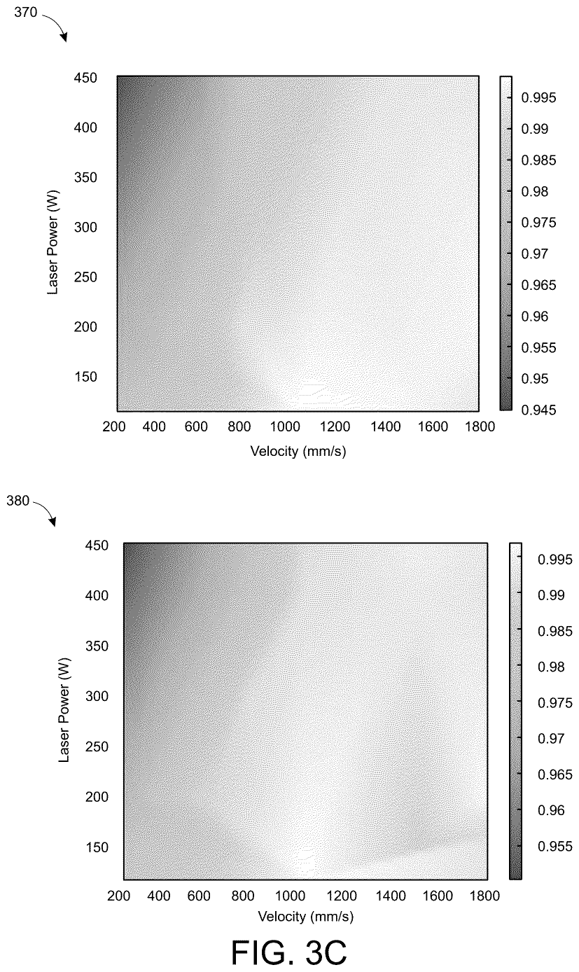

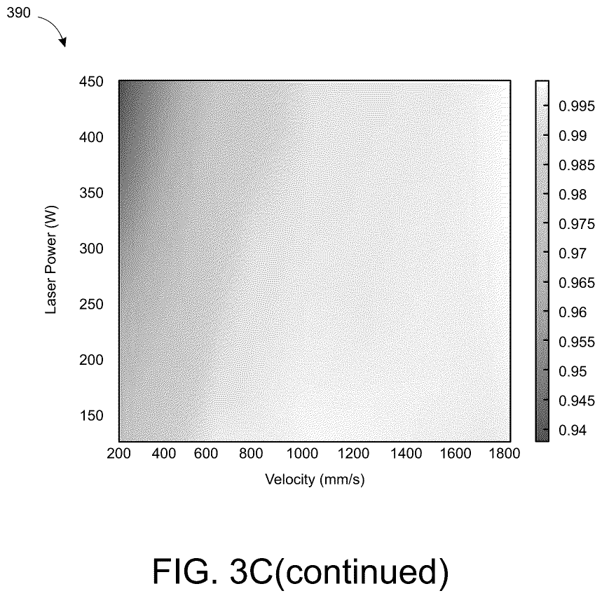

To investigate further the dynamic changes in melt pool shapes that can be captured by the imaging setup, changes in the maximum intensity of melt pool captured emissions and the cross-correlation of subsequent frames were analyzed. As shown in graphs 300, 310, and 320 of FIG. 3A, melt pools with severe keyholing have the highest fluctuation range, whereas tracks printed in conduction modes show more stable. The keyhole fluctuation is typically characterized by the fluctuations in the width and depth of the keyhole.

The temporal changes of the melt pool shapes are qualitatively analyzed by calculating the correlation coefficient between subsequent frames. Box plots of the correlation coefficients calculated for melted beads at different regimes are illustrated in FIG. 3B in graphs 340, 350, and 360. To depict how the melt pool changes over time at different levels of energy density, the average values are plotted in the power-velocity (P-V) maps 370, 380, and 390 as shown in FIG. 3C.

### Vision Transformer Model Development

Transformers are self-attention deep learning architectures. Pure transformers without recurrent or convolutional layers can overcome challenges that face other sequence modeling approaches such as vanishing gradient in long-range sequences and the inability of parallelization. Effectiveness of pure transformers in computer vision and achieved outstanding results compared to convolutional neural networks. The transformer layers consist of layer normalization, multi-headed self-attention, multilayer perceptron (MLP) of linear projects, and Gaussian Error Linear Unit (GELU non-linearity). The captured videos 112 are post-processed and divided into nonoverlapping 3D patches across the temporal and spatial domains and then linearly projected along with the positional embedding of the patches to the transformer encoder 120 as depicted in FIG. 1B. This method of extracting and feeding the temporal-spatial information to the model is called tubelet embedding. Due to the small field of view of the high-speed camera and the high scan speed of the laser, a limited number of frames are stored in each recorded video. Thus, regularization schemes efficiently deal with the small sizes of data. Biases and layer weight regularization are applied to the MLP of the multiheaded transformers and the MLP head. Although data augmentation is found to be powerful in boosting the performance of transformers, the data processing system uses regularization to preserve dynamic changes in the molten pool that are reflected in image intensity and changes in geometrical attributes. In some implementations, pretrained models can be used.

### Process Parameters Mapping

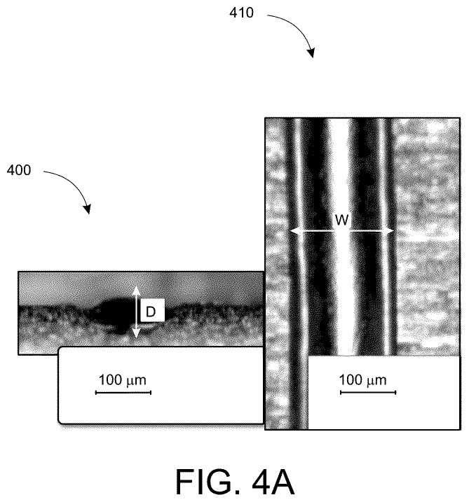

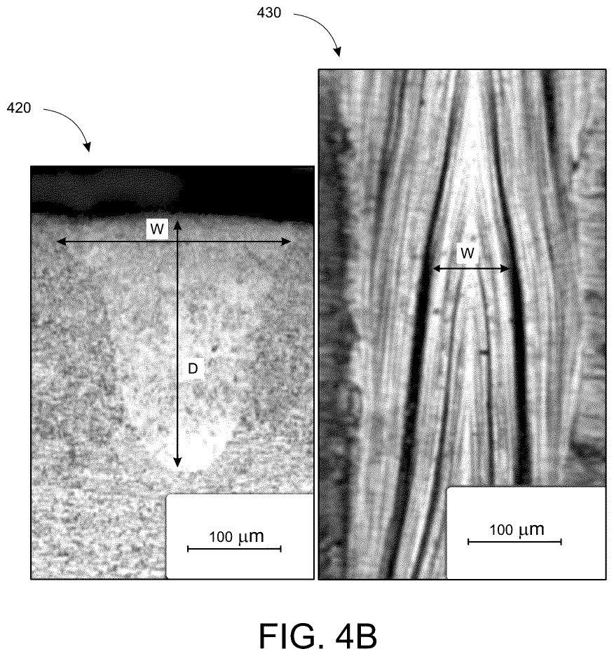

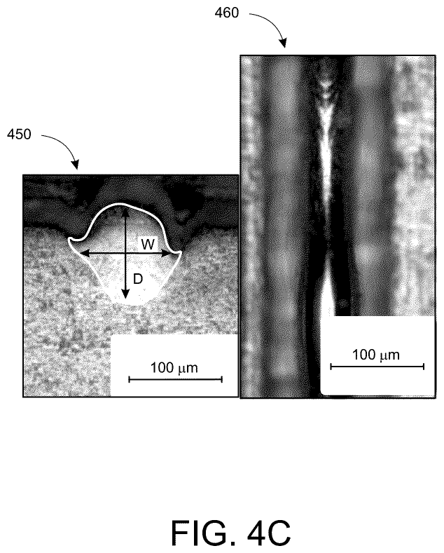

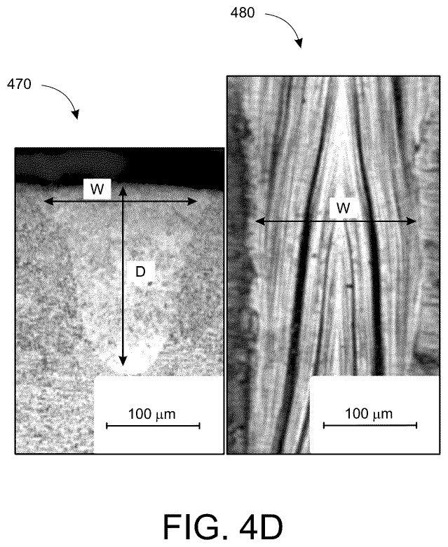

The videos are classified into four categories 124: desirable and printing regimes that can result in different types of defects: keyholing, balling, and lack-of-fusion. Keyholing is deep drilling into the material due to vaporization that results in a deep vapor cavity. Although keyholing can happen at other printing regimes, in this context, we refer to keyholing defects, which are characterized by unstable, deep, and narrow penetration and can lead to enclosed pores inside the printed parts. These cavities are initiation spots of cracks and thus can degrade the fatigue life of the parts. Another type of defect is balling, also called humping up. In the balling regime, owing to Plateau-Rayleigh instability and Marangoni flow the melted tracks exhibit a rough surface with periodic ball cross-section shape, and are associated with undercuts at the corners. The last class of defect is lack-of-fusion where energy density is not sufficient to fully melt the powder and so un-melted powder and irregular gaps are observed between melted tracks. Examples of the four printing classes are illustrated in FIGS. 4A-4D. FIG. 4A shows lack of fusion images from a side view 400 and a top view 410. FIG. 4B shows images of a desirable result from a side view 400 and a top view 410. FIG. 4C shows images of examples of balling from a side view 450 and a top view 460. FIG. 4D shows images of examples of keyholing from a side view 470 and a top view 480. Each of these outcomes can be determined based on characteristic widths W and depths D of the melt pools, as shown in FIGS. 4A-4D.

Single-bead experiments were performed at different P-V combinations, covering the four printing regimes, on the stainless steel 316L, the titanium alloy Ti-6AL-4V, and the Inconel alloy IN718. To explore the generalizability of the method, a cross-dataset evaluation was performed where the model is trained on the recorded videos of one alloy and tested on the others while the hyperparameters are kept unchanged. The classification results of the training experiment on 316L alloy are listed in Tables 1 and 2 respectively.

TABLE 1
Results of defects and processing regimes
prediction by testing on IN718.

| | precision | recall | f1-score | Samples |
|---|---|---|---|---|
| Desirable | 0.99 | 1.00 | 0.99 | 428 |
| Keyholing | 1.00 | 0.98 | 0.99 | 334 |
| Balling | 1.00 | 1.00 | 1.00 | 213 |
| Lack-of-fusion | 0.99 | 0.99 | 0.99 | 568 |

TABLE 2
Results of defects and processing regimes
prediction by testing on Ti-6AL-4V.

| | precision | recall | f1-score | Samples |
|---|---|---|---|---|
| Desirable | 0.68 | 0.86 | 0.76 | 166 |
| Keyholing | 0.94 | 0.98 | 0.96 | 441 |
| Balling | 1.00 | 0.52 | 0.69 | 142 |
| Lack-of-fusion | 0.97 | 1.00 | 0.98 | 291 |

The Top-1 and Top-2 accuracies obtained by running inference on IN718 alloy dataset are 96.63% and 100% respectively, whereas the achieved accuracies of the Ti-6AL-4V alloy are 87.60% and 95.87%. F-1 score, which is a combined measure of recall and precision of classification, ranges from 0.69 in Ti-6Al-4V balling to 1.0 in the case of IN718. The classification accuracy of Ti-6Al-4V is expected to be lower than that of IN718 alloy. In conducted experiments, the Ti-6Al-4V alloy is observed to emit a denser vapor plume in comparison to the other alloys. Ti-6A1-4V has significant vaporization of its alloy elements in comparison to 316L and IN718 (43). Moreover, Ti-6A1-4V has lower thermal conductivity and higher absorptivity to laser radiation, and much different thermo-physical properties.

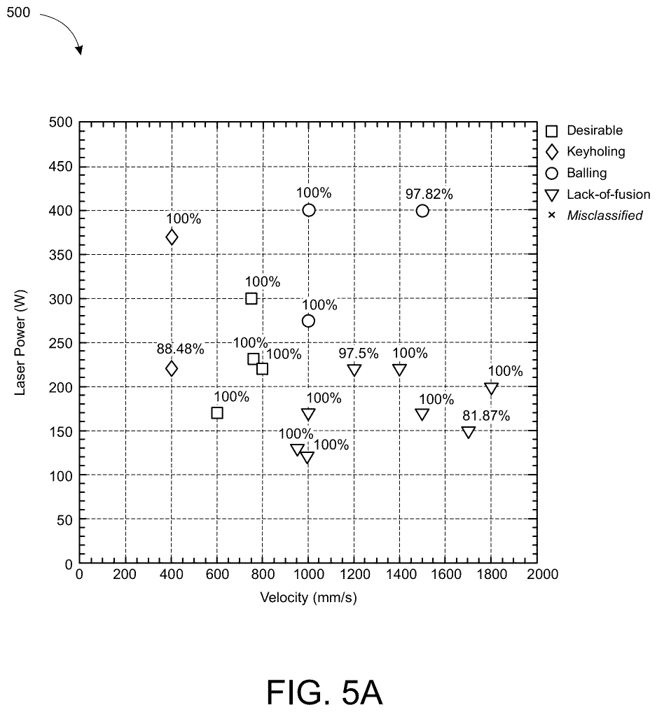

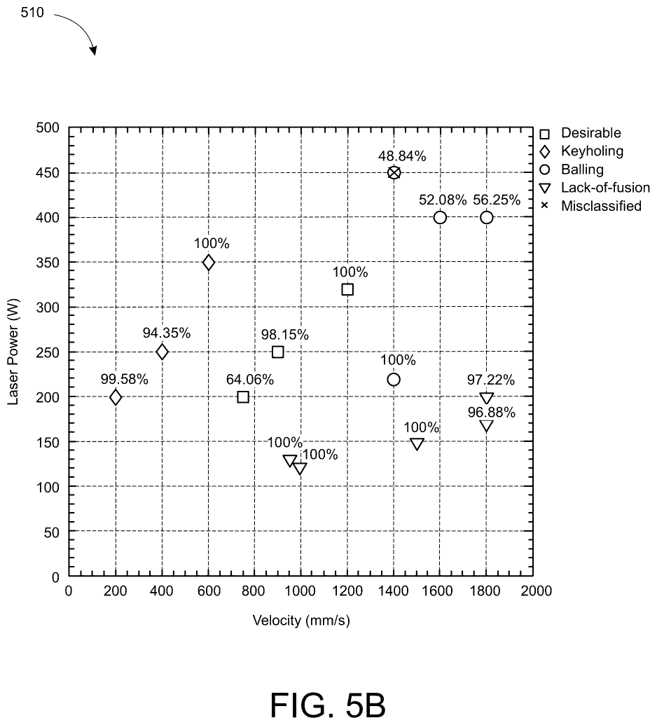

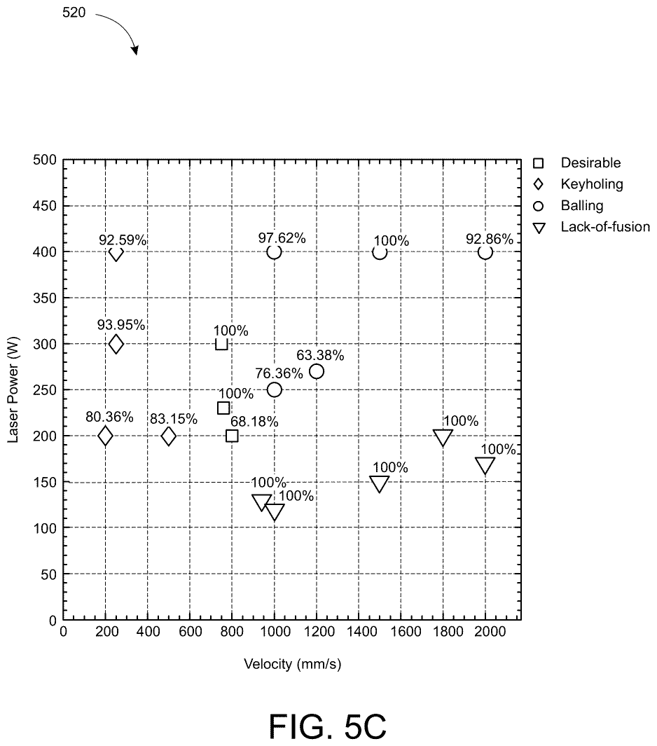

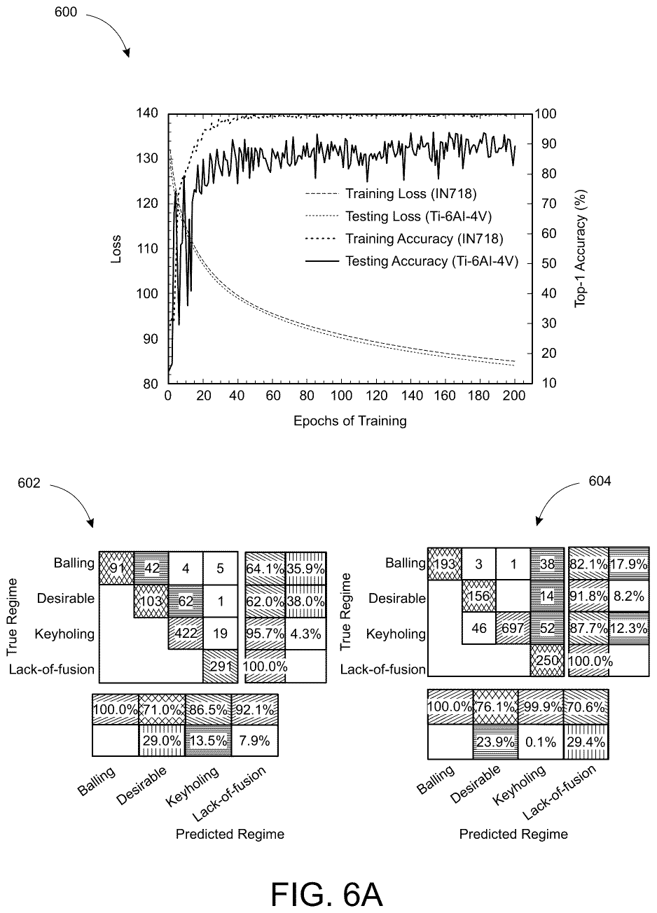

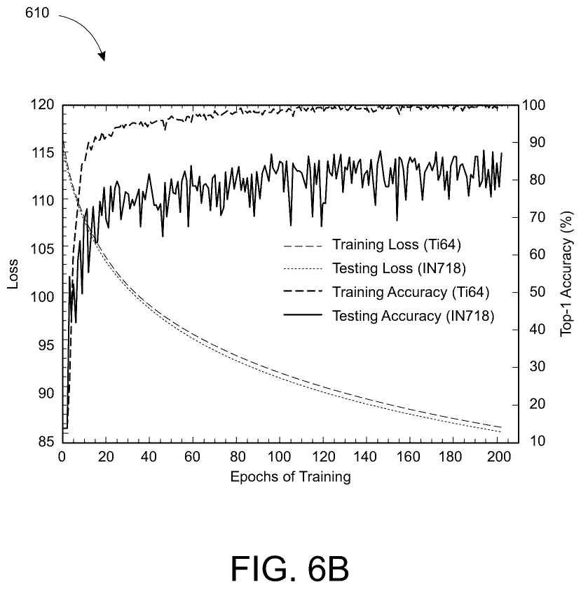

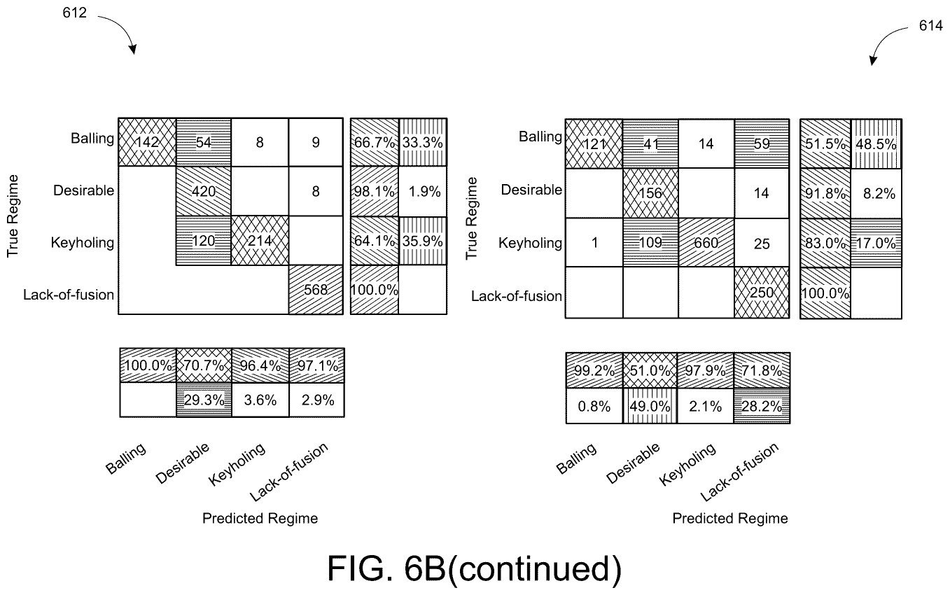

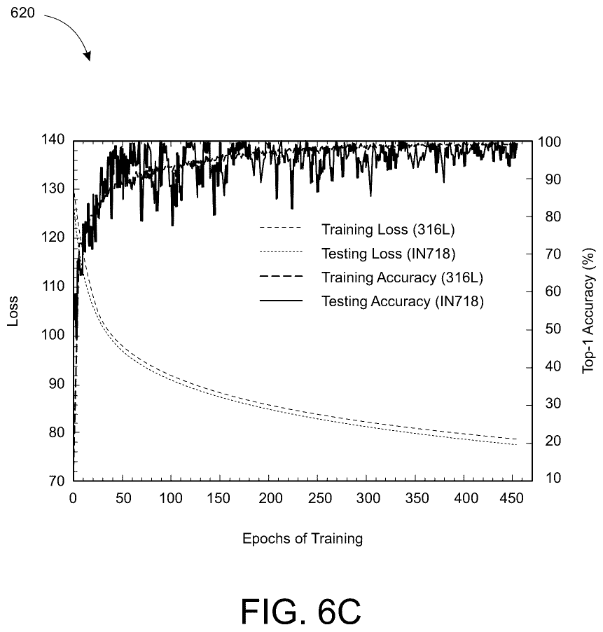

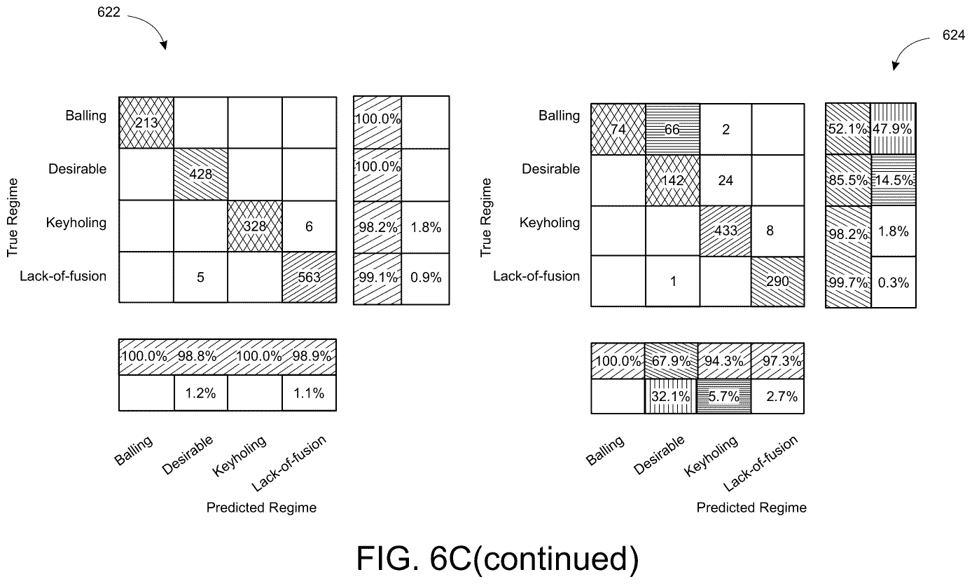

After classification, the classes of the P-V combinations are averaged across the samples in the testing datasets and plotted to generate process maps. The process maps or printability maps are maps of the resultant printing outcome for P-V combinations. Power and velocity are the two main controllable processing parameters that determine the input energy density and therefore have a major influence on the dynamics of the molten pool and its stability. Graph 500 of FIG. 5A, graph 510 of FIG. 5B, and graph 520 of FIG. 5C are process maps generated by the in-situ method with the vision transformer model. The process maps generated by this method are found to be in good agreement with the maps generated after ex-situ characterization of printed beads. There is no clear boundary between these classes. Keyholing may occur in desirable tracks and co-exist with balling without forming pores. Moreover, balling can occur in shallow melt pools as well as in melt pools with elongated keyholes. For instance, as shown in graph 510 of FIG. 5B, although the printed beads at 220W and 1400 mm/s are very shallow and can lead to lack-of-fusion defects, they are labeled in the current study as balling since beading up is observed on the track surface. Example validation results 600, 610, and 620 and confusion matrices 602, 604, 612, 614, 622, and 224 are shown in FIGS. 6A, 6B, and 6C. These results are proof-of-concept results to validate the process and are representative and non-limiting.

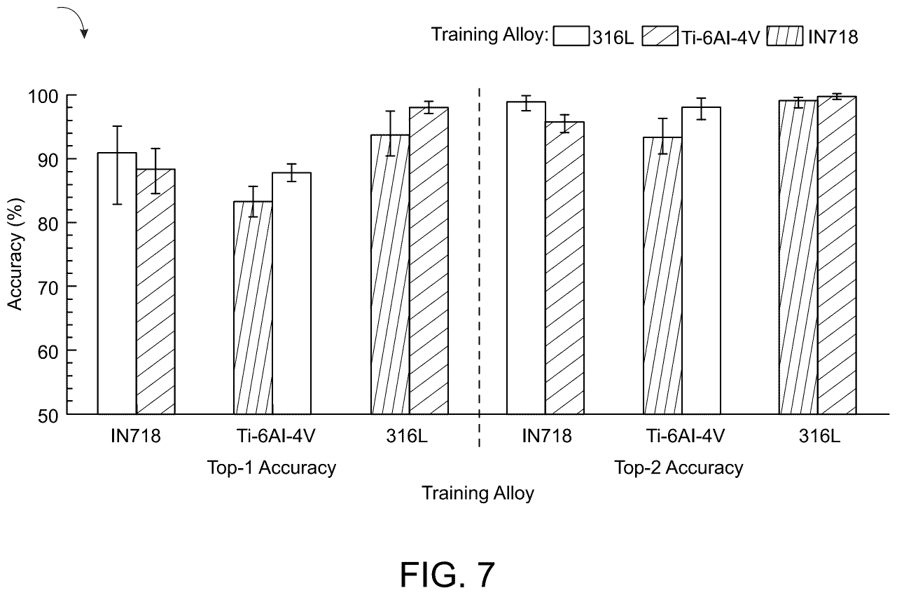

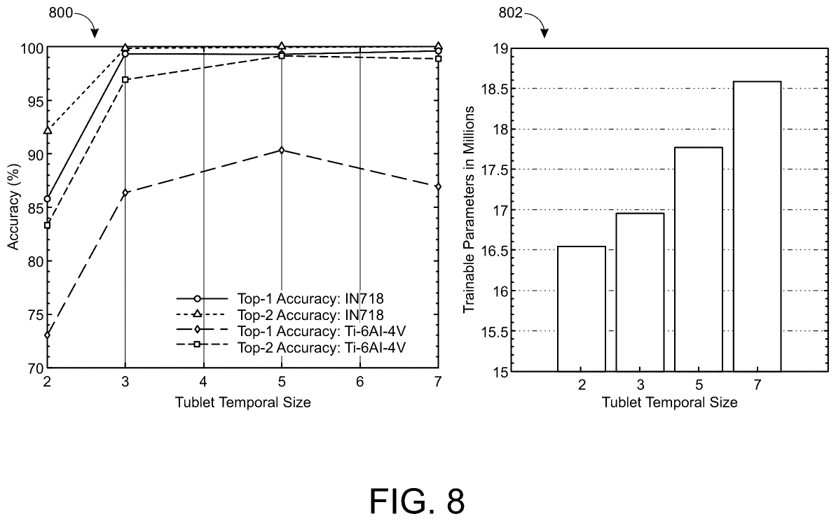

To test the influence of random initiation, the experiments are repeated five times with a different random seed and training data shuffling. Bar plots 700 of the classification accuracies of FIG. 7 is trained from scratch and the training data is shuffled in each experiment. However, the accuracy values are still reasonably high. The effect of the backbone capacity on the performance is illustrated in graph 800 and plot 802 of FIG. 8. Although the accuracy can be improved by increasing the backbone capacity, sufficient temporal context is used to extract meaningful patterns for the dynamics of the melt pool. In this particular classification problem, the model distinguishes the same object and the same action, but with different topological shapes and dynamics. On the other hand, in most of the other classification problems, the task is to classify different objects or distinct actions.

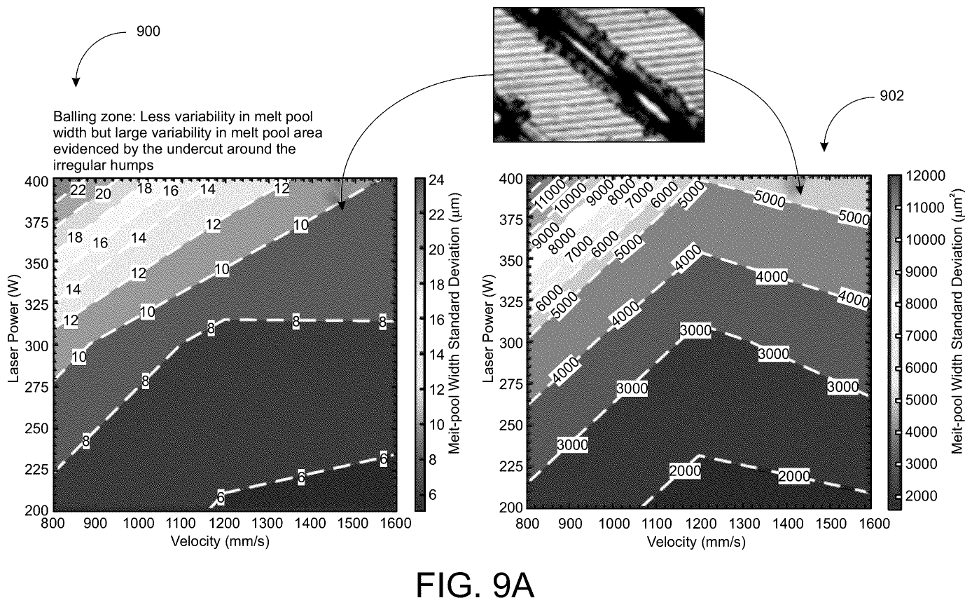

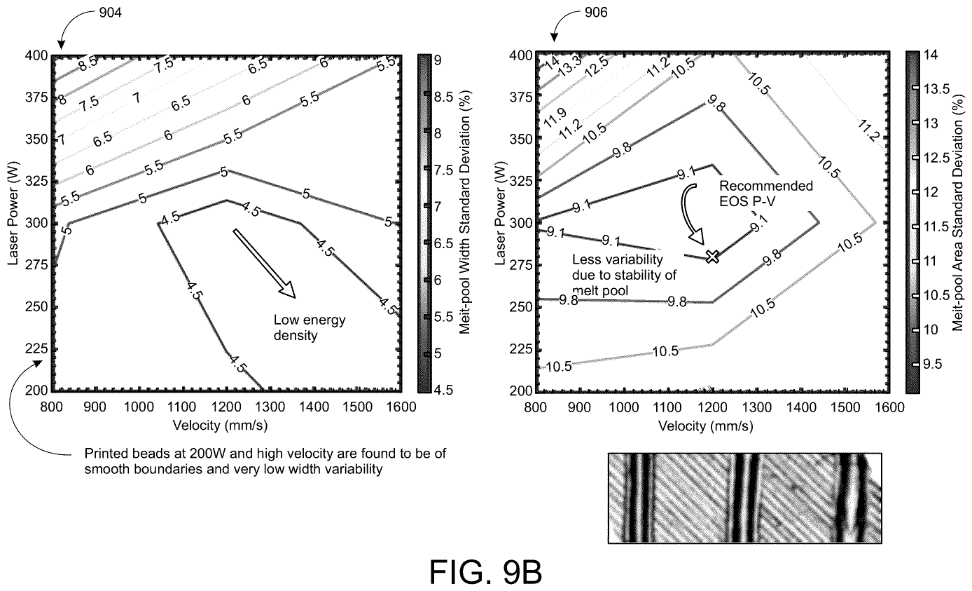

FIG. 9 shows graphs 900, 902, 904, and 906 each representing a process maps of melt pool morphological variability of Ti-6A1-4V alloy represented by the standard deviation of width and area of melt pools captured by high-speed imaging at 54k. Standard deviation values are in millimeters. Relative standard deviation is calculated as the percentage of the standard deviation value to the arithmetic mean value.

To validate the performance of the method, experiments are performed to compare the video vision transformer with other state-of-the-art models. Two pre-trained video vision transformer models ViViT-B and TimeSformer are compared with Deep Convolutional Network (VGG16), Deep Residual model (ResNet152), and Mobile Video Network model (MoViNet-A1). As the results in Table 3 show, the video vision transformer models outperform the CNN-based models. The pre-trained ViViT-B model has a more balanced performance between the test datasets, achieving classification accuracy higher than 90%.

TABLE 3
Comparison of classification accuracies (%) obtained
by state-of-the-art CNN and transformer-based models

| Training | Testing | | | MovieNET- | | |
|---|---|---|---|---|---|---|
| on | on | VGG16 | ResNET152 | A3 | TimeSformer | ViViT-B |
| Ti—6Al—4V | 316L | 83.30 | 87.48 | 81.96 | 88.80 | 90.24 |
| | IN718 | 82.50 | 90.72 | 82.99 | 92.36 | 94.48 |
| 316L | Ti—6Al—4V | 86.70 | 84.99 | 88.56 | 90.52 | 90.22 |
| | IN718 | 97.37 | 96.36 | 98.26 | 97.38 | 98.04 |
| IN718 | Ti—6Al—4V | 88.37 | 90.12 | 93.67 | 95.54 | 94.36 |
| | 316L | 89.39 | 93.22 | 92.06 | 90.80 | 92.48 |

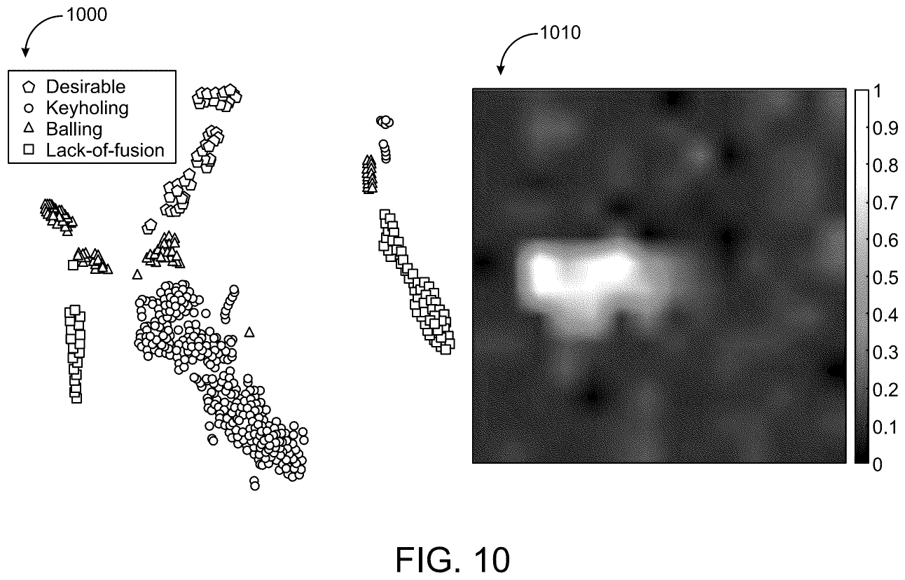

To provide more insights on the method performance, the t-SNE projection is visualized. This includes a technique used for visualization of high data dimensions, of the ViViT-B model features. Graph 1000 of FIG. 10 shows the plot of the defects in the space. Graph 1000 illustrates separable melt pool classes. An attention map 1010 illustrates the mean attention weight over the transformer heads after linear scaling. The map 1010 shows that the dynamic features of the melt pool at the keyhole and the tail carry more attention.

### Variability Mapping

Variability in melt pool morphologies can lead to dimensional inconsistency of printed features and coarse surface finish. Moreover, it can be an indication of heat accumulation and fusion defects, such as a discontinuity in melt track and spatters generation and powder spreading defects. Therefore, selecting process parameters that lead to a less variable melt pool can enhance the consistency of the printing outcome.

Following the creation of process maps for printability and defect formation, the process maps 902, 904, 906, and 908 for morphological variability of FIG. 9 are constructed. Although the depth of the melt pool cannot be seen from the top view of the machine bed, the width and area can be other attributes that are markers of printing consistency.

Powder single beads are printed in Ti-6Al-4V alloy with a layer thickness of 30 μm, 100 μm laser spot diameter, and different processing parameters combinations: laser power of 200, 300, and 400 Watts and scanning speed of 800, 1200, and 1600 mm/s. The experiments were conducted four times to account for variability in powder spreading in addition to analyzing sufficient melt-pool travels. Following printing the beads and collecting the data, ex-situ analysis with the ZEISS Axio Imager microscope is performed to measure the track width at every 200 μm. The liquidus-solidus pool threshold in captured videos is estimated by correlating the actual bead's mean width with the melt captured by the camera.

The variability in melt-pool morphology represented by the standard deviation of melt pool width and area is illustrated in graphs 900, 902, 904, and 906 of FIG. 9. A large standard deviation is observed at high energy density where the melt pools are large and diminish as the energy density decreases. The percentage of standard deviation of 902 also generally follows the same trend. Although the width variability is not high, the variation in the melt-pool area is significant. As observed by the microscope, beads with balling can be of smooth boundaries as the undercuts occupy the areas around the irregular humping-up features at the center of the beads. Beads printed at 200 Watts (W) of power and high velocities are found to be of smooth boundaries and small width standard deviation. This finding agrees with the ex-situ observations of the printed beads. An interesting finding is that the recommended P-V combination by the machine manufacturer is at the lowest area variability of the melt pool, which is an indication of melt-pool stability.

### Data Processing

The recorded videos were processed using scaling and image registration. The frames were converted into grayscale arrays and the molten pools were registered to be in the same location along each clip. The image intensity is normalized. For each video, the pixel intensities are linearly scaled from zero to one, where one represents the maximum pixel intensity in the video. The size of each data point is (80×160×15). That represents a temporal resolution of 18.5 microseconds (μs) and a spatial resolution of 6.3 micrometers (μm). Active contouring followed by thresholding was used to measure the melt pool attributes for the attribute variability analysis. The ground truth labeling is performed based on four classes: (1) keyholing defects: when the keyhole penetrates deep enough into the material with a probability to generate pores (width to depth ratio is less than 1.2 (10, 61) or if keyholing porosities are observed, (2) balling: any track that exhibits peaks with ball-like shape is classified as balling even if the track is shallow, (3) lack-of-fusion: when the printed track is very shallow and no balling is observed, (4) desirable: if the track does not meet the criteria of the other classes.

### Deep Learning Model

An example model 120 includes a video vision transformer ViViT, which is a pure-transformer model with a tubelet embedding of the video clips (e.g., feeding the model with non-overlapping spatiotemporal information. The architecture of the model 120 is illustrated in FIG. 1C. The extracted information from the input 148 contains both spatial and temporal information for the melt pool as the laser travels. The spatiotemporal attention 146 model is used with the transformer encoder which includes multi-head self-attention and MLP 142 with layer normalization 144 and residual connections. The model has 12 transformer heads, 20 layers, and the MLP hidden dimension is 256. To mitigate overfitting, we use the elastic net method, applying L1 and L2 weight regularization to the MLP layers. The calculations are performed on TensorFlow. The number of training epochs ranges between 200 to 500 depending on convergence, and the batch size is set to 128. This is an example and is not limiting. Other machine learning models can be used.

Although the techniques described in the present disclosure are applicable to a wide range of thermal processing methods, various implementations will be described below in the context of additive manufacturing involving a melt pool. While specific implementations are described, other implementations may exist that include operations and components different than those illustrated and described below. For example, the techniques described herein can be used to develop AM or direct digital manufacturing processes that involve the feeding of material in wire or powder or other form into a melt pool. The techniques described herein can be applied to a variety of processes involving the formation of a melt pool, such as welding processes (even if not used to build a shape). These techniques may also be applied to other AM processes that do not involve the direct feeding of material into the melt pool, such as (but not limited to) powder bed AM processes, and to analogous welding processes.

To demonstrate the effectiveness and generalizability of our approach, we have trained our method on titanium alloy Ti-A16-V4 and tested it on two alloys with different compositions, intrinsic thermal properties, and absorptivity of laser radiation, namely the nickel alloy IN718 and stainless-steel alloy 316L. The experiments have been conducted on the laser powder bed fusion (L-PBF) machine TruPrint 3000 with base plates of certified alloys from McMaster-Carr, Illinois, USA. The datasets we have generated span a wide scope of process parameters that cover the power-velocity space to ensure unbiasedness in the datasets. Results showing frames captured and processed by our method are illustrated in FIG. 10. Our method has achieved Top-1 testing accuracy of 85.3% and 85.52% on IN718 and 316L datasets respectively, and the Top-2 accuracies are 91.19% and 91.72%. In these experiments, data augmentation, hyperparameter optimization, and cross-validation are not implemented in our machine-learning algorithm. These techniques to reduce overfitting and optimize the deep learning architecture can boost accuracy. In the results presented herein, a baseline implementation is performed to demonstrate the effectiveness and generalizability of our method.

Given the generalizability of this method, it can be used in other fusion-based manufacturing processes such as the weldability of new alloys and process design for welding. Other metal additive manufacturing methods that rely on melting and fusing metal powder as direct energy deposition can also be possible applications. As the length and temporal scales differ for these processes, the thermo-fluid dynamics can dramatically change. Therefore, the algorithm should be tuned and trained when it is used for a different manufacturing process. This process has been tested on laser powder bed fusion. The concept is valid and scalable to larger spatial and temporal scales given that it is customized for the process scale. The method is developed for the purpose of process design for new alloys.

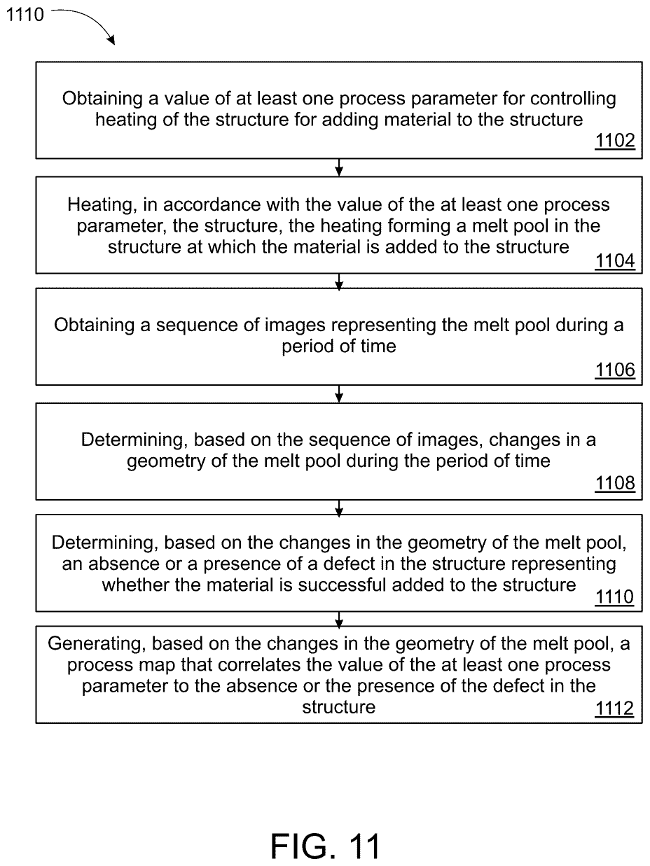

FIG. 11 shows an example process 1100 for generating a process map for forming a structure, the process map usable for controlling additive manufacturing with the structure. The process 1100 includes obtaining (1102) a value of at least one process parameter for controlling thermo-fluid dynamics of the structure for melting material to add the material to the structure. The process 1100 includes heating (1104), in accordance with the value of the at least one process parameter, the structure, the heating forming a melt pool in the structure at which the material is added to the structure. The process 1100 includes obtaining (1106) a sequence of images representing the melt pool during a period of time. The process 1100 includes determining (1108), based on the sequence of images, changes in a topological shape of the melt pool during the period of time. The process 1100 includes determining (1110), based on the changes in the topological shape of the melt pool, an absence or a presence of a defect in the structure representing whether the material is successful added to the structure. The process 1100 includes generating (1112), based on the changes in the topological shape of the melt pool, a process map that correlates the value of the at least one process parameter to the absence or the presence of the defect in the structure.

In some implementations, determining, based on the changes in the topological shape of the melt pool, the absence or the presence of the defect in the structure comprises: segmenting the sequence of images into non-overlapping three-dimensional (3D) patches in each of a spatial domain and a temporal domain; accessing a video vision transformer model comprising a multilayer perceptron (MLP) module; generating a linear projection of each the 3D patches in each of the spatial domain and the temporal domain; associating each linear projection with a positional embedding value; and generating, by feeding each linear projection and associated positional embedding value into the MLP module, a classification of the sequence of images as representing the absence or the presence of the defect in the structure.

In some implementations, the absence of the defect is indicative that the value of the at least one process parameter is within a process window for adding the material to the structure to cause a depth to width melt pool ratio of between 5:6 to 1:2, as seen in the images of FIGS. 4A-4D. In some implementations, the presence of the defect is indicative of at least one of a keyhole formation at the melt pool, a balling formation at the melt pool, or a lack of fusion of the material to the structure. In some implementations, determining, based on the sequence of images, changes in the topological shape of the melt pool during the period of time comprises: determining, for each image in the sequence of images, an area of the melt pool, a width of the melt pool, or each of the area and the width; and determining a value of a statistical variability of the area, the width, or both, wherein determining the absence or the presence of the defect in the structure is based on the value of the statistical variability.

In some implementations, the value of statistical variability comprises a standard deviation value.

In some implementations, the process 1110 includes normalizing an image intensity across the sequence of images by linearly scaling pixel intensities in each image.

In some implementations, the process 1100 includes filtering, from the each of the images of the sequence, distortions caused by vapor plasma in one or more of the images in the sequence of images based on application of an optical filter that blocks a set of wavelengths associated with peak or near-peak emissions of the vapor plasma.

In some implementations, the process 1100 includes based on application of a pixel intensity threshold, determining, from the sequence of images representing the melt pool, an estimated melt pool boundary; measuring a width of the material that is deposited on the structure corresponding to the period of time; generating a correction factor based on a correlation between the width of the material and the estimated melt pool boundary; and generating, based on the correction factor and the estimated melt pool boundary, data representing a corrected melt pool boundary.

In some implementations, determining the changes in the topological shape of the melt pool during the period of time is based on the corrected melt pool boundary.

In some implementations, the process 1100 includes correlating the correction factor to at least one setting for a sensor for capturing the sequence of images.

In some implementations, the at least one process parameter is selected from a group comprising a laser power (P) for a laser configured to heat the structure or a translation speed (V) for moving the laser over the structure.

In some implementations, the process 1100 includes generating a process window based on the process map, the process window specifying one or more values for process parameters including the value of the at least one process parameter for controlling a microstructure of a particular alloy or metal forming the structure and avoiding defects in the structure.

In some implementations, the process 1100 includes generating a process window based on the process map, the process window specifying one or more values for process parameters including the value of the at least one process parameter for maximizing a build rate of a part including a particular alloy or metal forming the structure and avoiding defects in the structure.

In some implementations, the process 1100 includes generating a process window based on the process map, the process window specifying one or more values for process parameters including the value of the at least one process parameter for minimizing melt pool variability.

In some implementations, the process 1100 includes generating a process window based on the process map, the process window specifying one or more values for process parameters including the value of the at least one process parameter for minimizing a heat buildup in a part including a particular alloy or metal while forming the structure and avoiding defects in the structure.

In some implementations, the period of time is less than one millisecond.

In some implementations, the sequence of images is captured at a frame rate of at least 5,000 frames per second and up to 60,000 frames per second. In some implementations, the sequence of images captured include visible light, near-infrared radiation, or both.

In some implementations, the structure comprises one of a Ti-6Al-4V alloy, a SS316L allow, or a IN718 alloy.

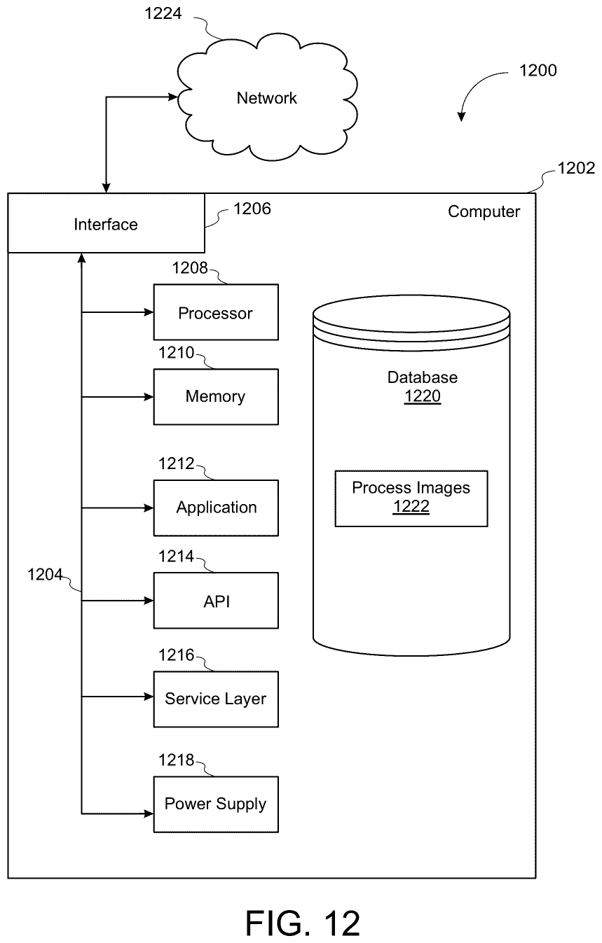

FIG. 12 is a block diagram of an example computer system 1200 used to provide computational functionalities associated with described algorithms, methods, functions, processes, flows, and procedures described in the present disclosure, according to some implementations of the present disclosure. The illustrated computer 1202 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1202 can include input devices such as keypads, keyboards, and touch screens that can accept user information. Also, the computer 1202 can include output devices that can convey information associated with the operation of the computer 1202. The information can include digital data, visual data, audio information, or a combination of information. The information can be presented in a graphical user interface (UI) (or GUI).

The computer 1202 can serve in a role as a client, a network component, a server, a database, a persistency, or components of a computer system for performing the subject matter described in the present disclosure. The illustrated computer 1202 is communicably coupled with a network 1224. In some implementations, one or more components of the computer 1202 can be configured to operate within different environments, including cloud-computing-based environments, local environments, global environments, and combinations of environments.

At a high level, the computer 1202 is an electronic computing device operable to receive, transmit, process, store, and manage data and information associated with the described subject matter. According to some implementations, the computer 1202 can also include, or be communicably coupled with, an application server, an email server, a web server, a caching server, a streaming data server, or a combination of servers.

The computer 1202 can receive requests over network 1224 from a client application (for example, executing on another computer 1202). The computer 1202 can respond to the received requests by processing the received requests using software applications. Requests can also be sent to the computer 1202 from internal users (for example, from a command console), external (or third) parties, automated applications, entities, individuals, systems, and computers.

Each of the components of the computer 1202 can communicate using a system bus 1204. In some implementations, any or all of the components of the computer 1202, including hardware or software components, can interface with each other or the interface 1206 (or a combination of both), over the system bus 1204. Interfaces can use an application programming interface (API) 1214, a service layer 1216, or a combination of the API 1214 and service layer 1216. The API 1214 can include specifications for routines, data structures, and object classes. The API 1214 can be either computer-language independent or dependent. The API 1214 can refer to a complete interface, a single function, or a set of APIs.

The service layer 1216 can provide software services to the computer 1202 and other components (whether illustrated or not) that are communicably coupled to the computer 1202. The functionality of the computer 1202 can be accessible for all service consumers using this service layer. Software services, such as those provided by the service layer 1216, can provide reusable, defined functionalities through a defined interface. For example, the interface can be software written in JAVA, C++, or a language providing data in extensible markup language (XML) format. While illustrated as an integrated component of the computer 1202, in alternative implementations, the API 1214 or the service layer 1216 can be stand-alone components in relation to other components of the computer 1202 and other components communicably coupled to the computer 1202. Moreover, any or all parts of the API 1214 or the service layer 1216 can be implemented as child or sub-modules of another software module, enterprise application, or hardware module without departing from the scope of the present disclosure.

The computer 1202 includes an interface 1206. Although illustrated as a single interface 1206 in FIG. 12, two or more interfaces 1206 can be used according to implementations of the computer 1202 and the described functionality. The interface 1206 can be used by the computer 1202 for communicating with other systems that are connected to the network 1224 (whether illustrated or not) in a distributed environment. Generally, the interface 1206 can include, or be implemented using, logic encoded in software or hardware (or a combination of software and hardware) operable to communicate with the network 1224. More specifically, the interface 1206 can include software supporting one or more communication protocols associated with communications. As such, the network 1224 or the interface's hardware can be operable to communicate physical signals within and outside of the illustrated computer 1202.

The computer 1202 includes a processor 1208. Although illustrated as a single processor 1208 in FIG. 12, two or more processors 1208 can be used according to implementations of the computer 1202 and the described functionality. Generally, the processor 1208 can execute instructions and can manipulate data to perform the operations of the computer 1202, including operations using algorithms, methods, functions, processes, flows, and procedures as described in the present disclosure.

The computer 1202 also includes a database 1220 that can hold data (such images 1222) for the computer 1202 and other components connected to the network 1224 (whether illustrated or not). For example, database 1220 can be an in-memory, conventional, or a database storing data consistent with the present disclosure. In some implementations, database 1220 can be a combination of two or more different database types (for example, hybrid in-memory and conventional databases) according to implementations of the computer 1202 and the described functionality. Although illustrated as a single database 1220 in FIG. 12, two or more databases (of the same, different, or combination of types) can be used according to implementations of the computer 1202 and the described functionality. While database 1220 is illustrated as an internal component of the computer 1202, in alternative implementations, database 1220 can be external to the computer 1202.

The computer 1202 also includes a memory 1210 that can hold data for the computer 1202 or a combination of components connected to the network 1224 (whether illustrated or not). Memory 1210 can store any data consistent with the present disclosure. In some implementations, memory 1210 can be a combination of two or more different types of memory (for example, a combination of semiconductor and magnetic storage) according to implementations of the computer 1202 and the described functionality. Although illustrated as a single memory 1210 in FIG. 12, two or more memories 1210 (of the same, different, or combination of types) can be used according to implementations of the computer 1202 and the described functionality. While memory 1210 is illustrated as an internal component of the computer 1202, in alternative implementations, memory 1210 can be external to the computer 1202.

The application 1212 can be an algorithmic software engine providing functionality according to implementations of the computer 1202 and the described functionality. For example, application 1212 can serve as one or more components, modules, or applications. Further, although illustrated as a single application 1212, the application 1212 can be implemented as multiple applications 1218 on the computer 1202. In addition, although illustrated as internal to the computer 1202, in alternative implementations, the application 1212 can be external to the computer 1202.

The computer 1202 can also include a power supply 1218. The power supply 1218 can include a rechargeable or non-rechargeable battery that can be configured to be either user- or non-user-replaceable. In some implementations, the power supply 1218 can include power-conversion and management circuits, including recharging, standby, and power management functionalities. In some implementations, the power-supply 1218 can include a power plug to allow the computer 1202 to be plugged into a wall socket or a power source to, for example, power the computer 1202 or recharge a rechargeable battery.

There can be any number of computers 1202 associated with, or external to, a computer system including the computer 1202, with each computer 1202 communicating over network 1224. Further, the terms “client,” “user,” and other appropriate terminology can be used interchangeably, as appropriate, without departing from the scope of the present disclosure. Moreover, the present disclosure contemplates that many users can use one computer 1202 and one user can use multiple computers 1202.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

Other embodiments are within the scope of the description claims.

Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of exemplary implementations of the invention have been described. Nevertheless, it will be understood by one of ordinary skill in the art that various modifications may be made without departing from the scope of the processes and systems described herein and subsequently claimed.

1. A method for generating a process map for forming a structure, the process map usable for controlling additive manufacturing with the structure, the method comprising:
obtaining a value of at least one process parameter for controlling thermo-fluid dynamics of the structure for melting material to add the material to the structure;
heating, in accordance with the value of the at least one process parameter, the structure, the heating forming a melt pool in the structure at which the material is added to the structure;
obtaining a sequence of images representing the melt pool during a period of time;
determining, based on the sequence of images, changes in a topological shape of the melt pool during the period of time;
determining, based on the changes in the topological shape of the melt pool, an absence or a presence of a defect in the structure representing whether the material is successful added to the structure; and
generating, based on the changes in the topological shape of the melt pool, a process map that correlates the value of the at least one process parameter to the absence or the presence of the defect in the structure.

2. The method of claim 1, wherein determining, based on the changes in the topological shape of the melt pool, the absence or the presence of the defect in the structure comprises:
segmenting the sequence of images into non-overlapping three-dimensional (3D) patches in each of a spatial domain and a temporal domain;
accessing a video classification model comprising a multilayer perceptron (MLP) module;
generating a linear projection of each the 3D patches in each of the spatial domain and the temporal domain;
associating each linear projection with a positional embedding value; and
generating, by feeding each linear projection and associated positional embedding value into the MLP module, a classification of the sequence of images as representing the absence or the presence of the defect in the structure.

3. The method of claim 1, wherein the absence of the defect is indicative that the value of the at least one process parameter is within a process window for adding the material to the structure to cause a depth to width melt pool ratio of between 5:6 to 1:2.

4. The method of claim 1, wherein the presence of the defect is indicative of at least one of a keyhole formation at the melt pool, a balling formation at the melt pool, or a lack of fusion of the material to the structure.

5. The method of claim 1, wherein determining, based on the sequence of images, changes in the topological shape of the melt pool during the period of time comprises:
determining, for each image in the sequence of images, an area of the melt pool, a width of the melt pool, or each of the area and the width; and
determining a value of a statistical variability of the area, the width, or both,
wherein determining the absence or the presence of the defect in the structure is based on the value of the statistical variability.

6. The method of claim 5, wherein the value of statistical variability comprises a standard deviation value.

7. The method of claim 1, further comprising:
normalizing an image intensity across the sequence of images by linearly scaling pixel intensities in each image.

8. The method of claim 1, further comprising:
filtering, from the each of the images of the sequence, distortions caused by vapor plasma in one or more of the images in the sequence of images based on application of an optical filter that blocks a set of wavelengths associated with peak or near-peak emissions of the vapor plasma.

9. The method of claim 1, further comprising:
based on application of a pixel intensity threshold, determining, from the sequence of images representing the melt pool, an estimated melt pool boundary;
measuring a width of the material that is deposited on the structure corresponding to the period of time;
generating a correction factor based on a correlation between the width of the material and the estimated melt pool boundary; and
generating, based on the correction factor and the estimated melt pool boundary, data representing a corrected melt pool boundary.

10. The method of claim 9, wherein determining the changes in the topological shape of the melt pool during the period of time is based on the corrected melt pool boundary.

11. The method of claim 9, further comprising correlating the correction factor to at least one setting for a sensor for capturing the sequence of images.

12. The method of claim 1, wherein the at least one process parameter is selected from a group comprising a laser power (P) for a laser configured to heat the structure or a translation speed (V) for moving the laser over the structure.

13. The method of claim 1, further comprising:
generating a process window based on the process map, the process window specifying one or more values for process parameters including the value of the at least one process parameter for controlling a microstructure of a particular alloy or metal forming the structure and avoiding defects in the structure.

14. The method of claim 1, further comprising:
generating a process window based on the process map, the process window specifying one or more values for process parameters including the value of the at least one process parameter for maximizing a build rate of a part including a particular alloy or metal forming the structure and avoiding defects in the structure.

15. The method of claim 1, further comprising:
generating a process window based on the process map, the process window specifying one or more values for process parameters including the value of the at least one process parameter for minimizing melt pool variability.

16. The method of claim 1, further comprising:
generating a process window based on the process map, the process window specifying one or more values for process parameters including the value of the at least one process parameter for minimizing a heat buildup in a part including a particular alloy or metal while forming the structure and avoiding defects in the structure.

17. The method of claim 1, wherein the period of time is less than one millisecond.

18. The method of claim 1, wherein the sequence of images is captured at a frame rate of at least 5,000 frames per second and up to 60,000 frames per second.

19. The method of claim 1, wherein the sequence of images captured includes visible light, near-infrared radiation, or both.

20. The method of claim 1, wherein the structure comprises one of a Ti-6Al-4V alloy, a SS316L allow, or a IN718 alloy.

21-45. (canceled)
